(19) United States
(12) Patent Application Publication
(10) Pub. No.: US 2024/0138523 A1
(43) Pub. Date: May 2, 2024

(54) SYSTEMS AND METHODS FOR PROVIDING PERSONALIZED FOOTWEAR

(71) Applicant: Iambic Inc., New York, NY (US)

(72) Inventors: Maeve WANG, New York, NY (US); Chaudhry Raza HASSAN, Lake Grove, NY (US)

(21) Appl. No.: 18/279,707

(22) PCT Filed: Feb. 24, 2022
(86) PCT No.: PCT/US2022/017641

§ 371 Date: Aug. 31, 2023

Related U.S. Application Data
(60) Provisional application No. 63/155,171, filed on Mar. 1, 2021.
(60) Provisional application No. 63/277,818, filed on Nov. 10, 2021.

(51) Int. Cl. A43D 1/02

(52) U.S. Cl. CPC A43D 1/025; A43D 1/027

(57) ABSTRACT

In some embodiments, apparatuses and methods are provided herein useful to providing personalized footwear and/or generating personalized footwear recommendations. In some embodiments, systems and methods for providing personalized footwear may include or employ one or more of a foot shape module, a pathology module, a gait and biomechanics module, and a context module. The foot shape, pathology, gait, biomechanics, and context modules may acquire and analyze data related to foot shape, pathologies, gait, biomechanics, demographics, lifestyle, location, and/or product preferences associated with a user to determine one or more personal attributes associated with the user. In addition, the systems and methods provided herein may include or employ a footwear module to collect and analyze data related to construction, materials, material properties, category, style, and/or aesthetics of footwear products to determine footwear attributes associated with the products. Personal attributes and footwear attributes may be used to provide personalized footwear products and/or recommendations. In other embodiments, systems and methods for providing personalized footwear may include or employ sensors or analysis of previously worn footwear. The sensors may acquire, determine, or transmit data related to certain attributes associated with a user. Personal attributes and footwear attributes may be used to provide personalized footwear products, recommendations, and/or footwear lasts. In addition, the systems and methods provided herein may include or employ repeating certain steps to create a circular method of providing personalized footwear or providing personalized footwear lasts.

This application claims the benefit of U.S. Patent Application Nos. 63/155,171, filed Mar. 1, 2021, and 63/277,818, filed Nov. 10, 2021, the disclosures of which are incorporated by reference.

### TECHNICAL FIELD

This invention relates generally to personalized footwear, and more specifically, to providing footwear and/or recommendations using sensors to assess an individual's footwear needs and provide personalized feedback.

### BACKGROUND

Footwear fit has potential impacts on human, industry, and global level. Poor footwear fit may cause personal pain to a wearer, and has deep implications across the entire footwear industry value chain—from footwear design to manufacturing to retail. At a human level, foot health may play a central role in mobility and quality of life. Studies have shown that 63% to 72% of people wear ill-fitting footwear, the impact of which extends far beyond personal pain, resulting in deformities and disorders. Indeed, improperly fitting footwear have been shown to be associated with a number of medically related disorders (e.g., reduced short- and long-term mobility, lower quality of life, etc.) Discovering new, better-fitting footwear has generally been a manual trial-and-error process that wastes a consumer's time and money, and results in footwear that does not fit or footwear that causes pain.

The footwear industry's current sizing system oversimplifies fit and fails to capture the broad spectrum of foot morphologies, pathologies, and gait and biomechanics. For example, individuals with medical conditions (e.g., digital deformities, arthritis, diabetes, etc.) and older adults that have geriatric needs are hard to address through any existing footwear sizing/selection systems.

At the industry level, poor fit is cited among the top reasons for returns, estimated to cost footwear retailers billions annually for footwear purchase online, which includes the cost of shipping, processing fees, restocking fees, and the lost value of merchandize. On a global and more macro level, the footwear returns predicament is also driving the footwear industry's contributions to climate change. For example, returned merchandise may be donated or incinerated. Returned footwear also contributes to landfill waste and CO2 emissions.

Today, the footwear industry is poorly equipped to enable proper fit—there is no industry standard for footwear sizing, which may vary significantly across brands, footwear types, models, and annual versions, at a minimum. The industry's standard approach to sizing is two-dimensional, based on foot width and length; it fails to account for the foot's intricate shape, with its 26 bones, 33 joints, 100+ ligaments, tendons, and muscles. Nor does it account for personal gait: footwear are devices that enable people to move, devices that interest with each foot's 7,000+ nerve endings which send signals to the rest of the body in motion. Unlike garment fit, which can be approximate, footwear fit that is imperfect—without considering the foot's complexities in shape and movement—causes pain, a physiological sign of biofeedback that something is harmful to the body. Given the complex interaction between footwear and the human body's anatomy and physiological traits, understanding the science of footwear fit is critical to making appropriate footwear recommendations and resolving fit-induced returns.

Moreover, part of the issue also lies upstream in the footwear industry's value chain. For brands, footwear design practices remain archaic, where the sizing and fitting process still relies on trial-and-error with qualitative feedback from a limited sample of foot models. Brands lack the necessary data to optimize the designs of mass manufactured shoes to fit broader segments of the population. Even for brands to consider personalizing footwear manufactured for consumers, mass manufacturing techniques today are too inefficient to do so, resulting in wasted resources and labor. For this reason, custom-made footwear remains handcrafted, a costly and unscalable process, which drives the high cost and thereby price point for custom shoes beyond the reach of average consumers.

Additive manufacturing shows increasing promise: it presents an opportunity for the customization of complex products, while also limiting the quantity of resin materials, or polymers, necessary to create finished goods. Yet, the adoption of additive manufacturing is highly dependent on the greater availability of 3D data capturing technologies that can seamlessly acquire user biometric and geometric information.

Consumer online shopping solutions that are available to provide custom fit recommendations are incomplete and ineffective. Companies (e.g., online retail shoe sellers) have also relied on fit-prediction mobile phone applications that utilize foot scanning technologies to provide the wearer with better fit recommendations. However, both of the aforementioned categories of solutions are currently limited in the accuracy of their recommendations because they lack sufficient personal and/or product data.

### BRIEF DESCRIPTION OF THE DRAWINGS

Disclosed herein are embodiments of systems, apparatuses and methods pertaining to providing personalized footwear. This description includes drawings, wherein:

FIG. 1 is a simplified diagram of a method for providing personalized footwear, in accordance with some embodiments.

FIG. 2 is a simplified diagram of a method for conducting gait analysis to provide personalized footwear, in accordance with some embodiments.

FIG. 3 is a schematic illustration of an exemplary system for providing personalized footwear in accordance with some embodiments.

FIG. 4 is a flow diagram of a method of acquiring and displaying foot shape data, in accordance with some embodiments.

FIG. 5 is a flow diagram of a method of analyzing image data to determine foot shape attributes associated with a user, in accordance with some embodiments.

FIG. 6 is a flow diagram of a method of acquiring and displaying foot pathology data, in accordance with some embodiments.

FIG. 7 is a flow diagram of a method of analyzing image data to determine foot pathology attributes associated with a user, in accordance with some embodiments.

FIG. 8 is a flow diagram of a method of acquiring and displaying gait data, in accordance with some embodiments.

FIG. 9 is a flow diagram of a method of performing a gait assessment, in accordance with some embodiments.

FIG. 10 is a flow diagram of a method of acquiring and displaying contextual data associated, in accordance with some embodiments.

FIG. 11 is a flow diagram of a method of analyzing contextual data, in accordance with some embodiments.

FIG. 12 is a flow diagram of a method of acquiring and analyzing footwear data, in accordance with some embodiments.

FIG. 13 is a flow diagram of a method of providing personalized footwear and/or generating personalized footwear recommendations, in accordance with some embodiments.

FIG. 14 is a flow diagram of a method of providing or updating a personalized footwear recommendation, in accordance with some embodiments.

FIG. 15 is a flow diagram of a method of providing or updating a personalized footwear recommendation, in accordance with some embodiments.

FIG. 16 is a flow diagram of a method of analyzing sensor data to determine personal sensed attributes associated with a user, in accordance with some embodiments.

FIG. 17 is a flow diagram of a method of creating a digital drawing of a footwear recommendation, in accordance with some embodiments.

FIG. 18 is a flow diagram of a method of updating a personal foot model, in accordance with some embodiments.

FIG. 19 is a flow diagram of a method manufacturing and updating a footwear recommendation, in accordance with some embodiments.

FIG. 20 is a schematic illustration of an exemplary system for providing personalized footwear in accordance with some embodiments.

FIG. 21 is a flow diagram of a method of providing or updating a footwear recommendation, in accordance with some embodiments.

FIG. 22 is a flow diagram of a method of providing or updating a footwear recommendation, in accordance with some embodiments.

FIG. 23 is a flow diagram of a method of performing a biomechanics assessment, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are described herein which may be used to assess an individual's footwear needs in order to provide personalized footwear and/or generate personalized footwear recommendations. The systems and methods described herein may be used to provide footwear product recommendations and/or to generate personalized footwear specifications which may be used, for example, for custom footwear manufacturing. In some embodiments, the systems and methods provided herein may be used to collect and analyze comprehensive personal data associated with a user. Such personal data may include data related to the foot shape, foot pathologies, gait and biomehcanics, demographics, lifestyle, location, and/or product preferences associated with a user. In addition, the systems and methods provided herein may also be used to collect and analyze comprehensive data on footwear products. Such data may include, data related to the footwear product construction, materials, material properties, category, style, and aesthetics. In this manner, footwear products may be effectively matched to or personalized for the user.

It is contemplated that the systems and methods described herein may be employed by a number of potential users, including but not limited to, shoppers, consumers, businesses such as shoe retailers or shoe designers, electronic marketplaces, footwear manufacturers, footwear providers or suppliers, medical professionals, sales professionals, or any other entities involved in the provision, design, or manufacturing of footwear or footwear related products.

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

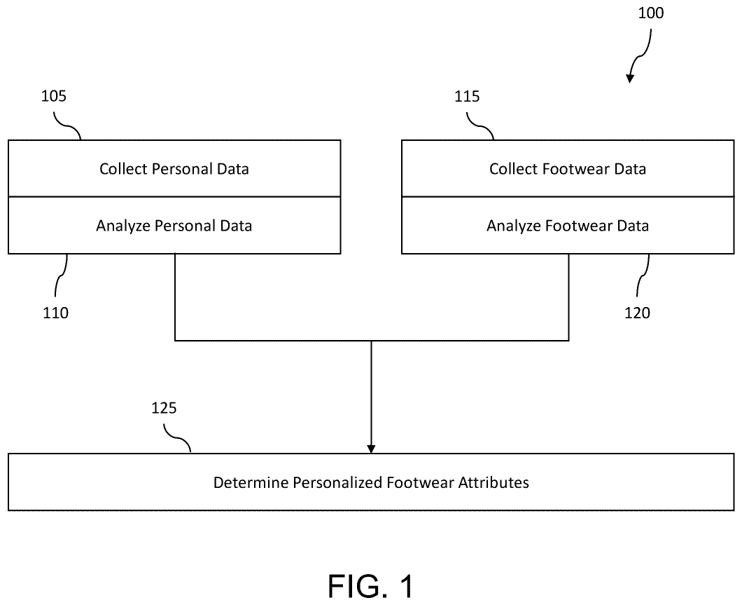

FIG. 1 illustrates a simplified overview of a method 100 for providing personalized footwear, in accordance with some embodiments. The method 100 includes both a personal assessment and a footwear assessment.

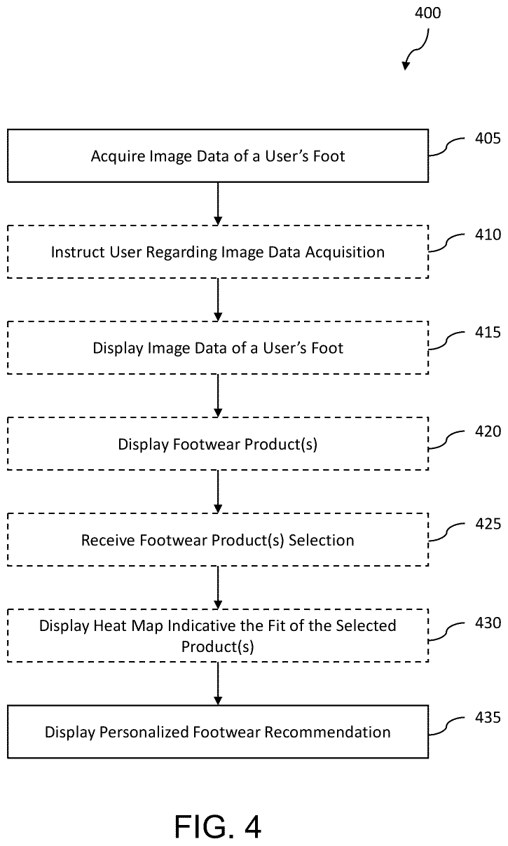

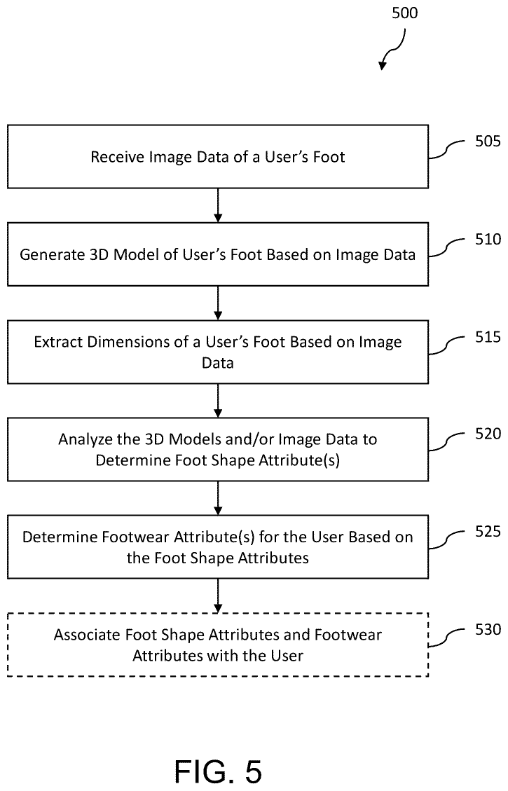

The personal assessment involves collecting 105 and analyzing 110 personal data associated with a user to determine one or more personal attributes that may impact the footwear needs, calculated footwear fit, or product recommendations for a user. Such personal data may include various forms of data, such as image data associated with a user, video data associated with a user, responses to electronic questionnaires, or responses to electronic requests for information from a user. Personal data may include one or more of personal foot shape data, personal pathology data, personal gait data, personal biomechanics data, and personal contextual data. In some approaches, the personal data may be collected 105 using one or more of the methods described with reference to FIGS. 4, 6, 8, and 11. The personal assessment further includes analyzing 110 the personal data to determine one or more personal attributes associated with a user. Such personal attributes may include one or more qualities, characteristics, or preferences that may impact footwear needs and fit. In some embodiments, personal data may be analyzed to determine one or more personal foot shape attributes associated with a user or individual. In some embodiments, personal data may be analyzed to determine one or more personal pathology attributes associated with a user. In some embodiments, personal data may be analyzed to determine one or more gait and biomechanics attributes associated with a user. In some embodiments, personal data may be analyzed to determine one or more personal contextual attributes associated with a user. In some approaches, the personal data may be analyzed using one or more of the methods described with reference to, for example, FIGS. 5, 6, 9, and 12.

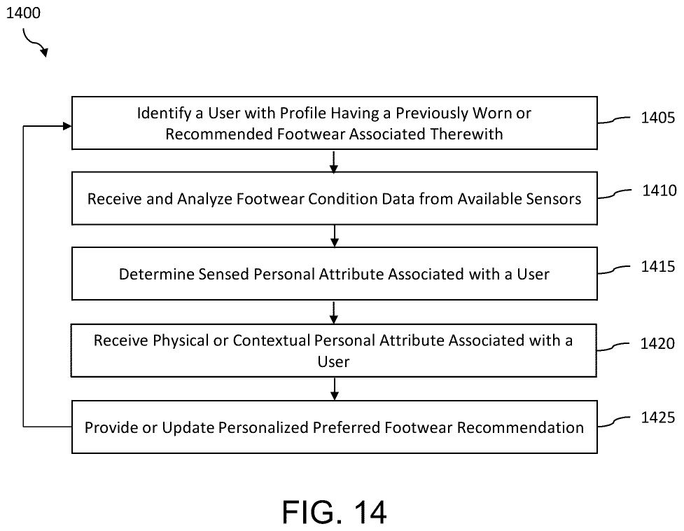

The footwear assessment involves collecting 115 and analyzing 120 footwear data associated one or more footwear products to determine one or more attributes of the footwear products. Such footwear data may include various forms of data such as image data, sensor data, test data, or product specifications. In some approaches, the footwear data may be collected using the method described with reference to FIG. 14. The footwear assessment further includes analyzing 120 the footwear data to determine one or more footwear attributes associated with a footwear product. Such footwear attributes may include one or more qualities, characteristics, or preferences associated with a footwear product that may impact footwear needs and fit. Footwear attributes may include footwear product specifications or properties such as product dimensions, geometry, material, material property, and style. In some approaches, the footwear data may be analyzed using the method described with reference to, for example, FIG. 14.

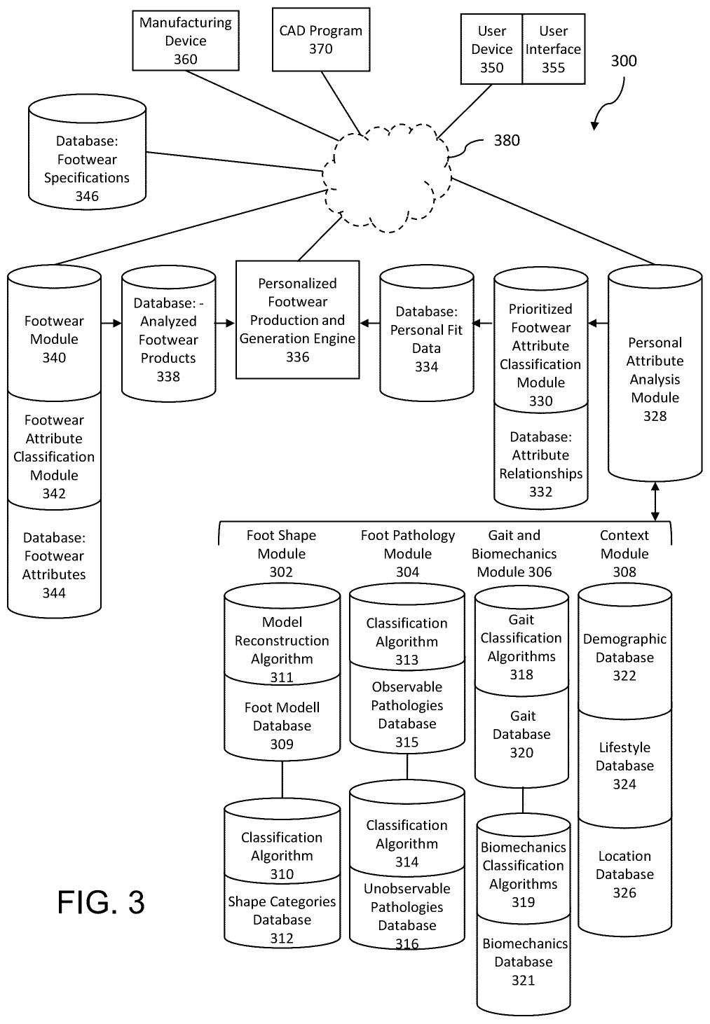

The method 100 also includes determining 125 one or more footwear attributes associated with the user based on the personal attributes associated with the user. In some approaches, personal data may be analyzed via one or more modules associated with a system for providing personalized footwear, such as the system 300 described with reference to FIG. 3.

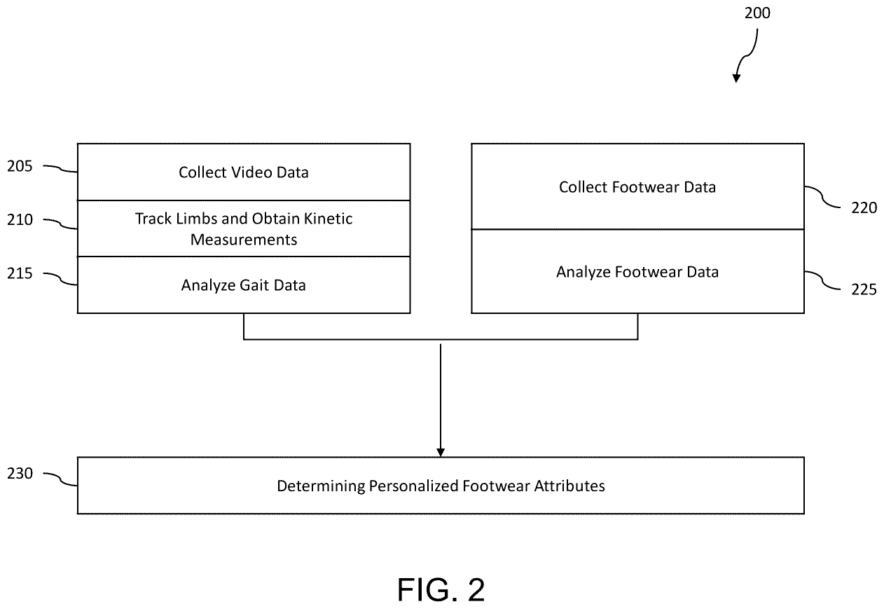

FIG. 2 is a simplified diagram of a method 200 for conducting gait analysis as part of a process to provide personalized footwear, in accordance with some embodiments. The method 200 includes a personal gait assessment and a footwear assessment.

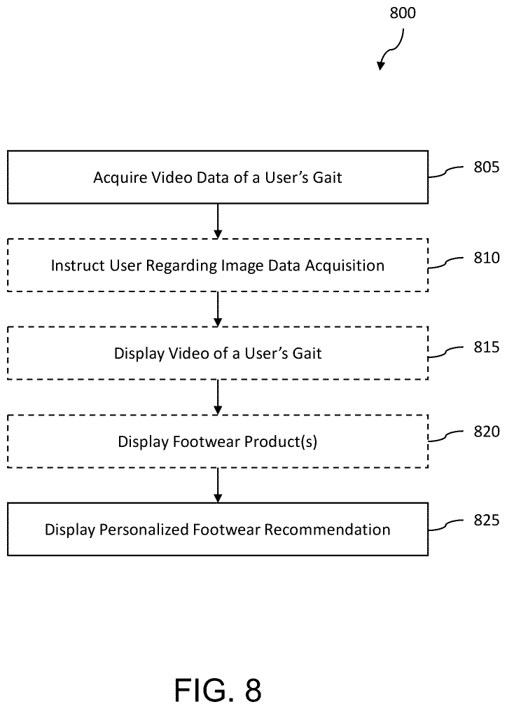

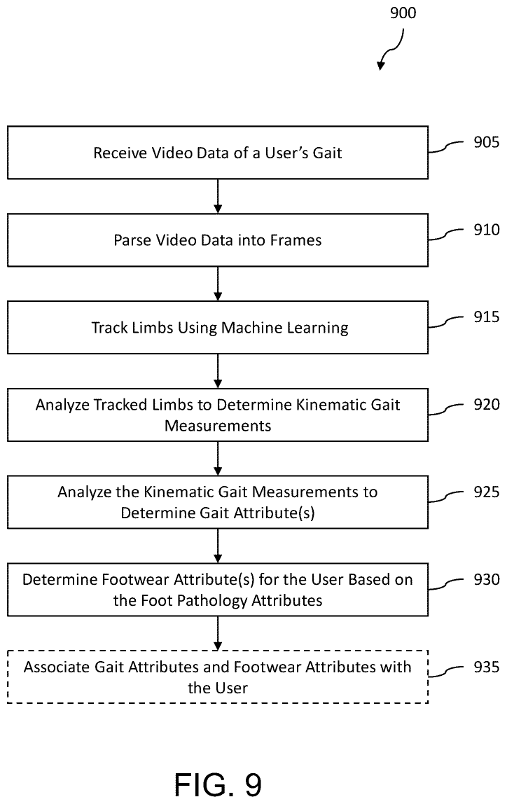

The personal gait assessment includes collecting 205 gait data to determine one or more personal gait and biomechanics attributes that may impact the footwear needs, calculated footwear fit, or product recommendations for a user. Such gait and biomechanics data may include various forms of data, such as image data or video data, associated with a user. For example, gait data may include a video capturing a user's gait (i.e., a user walking) under specified conditions and biomechanics data may include a pressure map of the foot plantar pressure during standing, walking, and/or doing any other activity. In some approaches, the gait and biomechanics data may be collected using the method described with reference to FIG. 8. The method further includes tracking 210 the user's limbs on the video and obtaining kinematic measurements by analyzing the tracked limbs. The gait data, tracked points, and kinematic measurements may be analyzed 215 to determine one or more gait attributes associated with the user. For example, such gait attributes may include step time, step length, gait speed, stance time, swing time, foot position, foot plantar flexion, ankle plantar flexion, knee flexion, joint loading foot loading, other lower limb kinetics, or other characterizations of the gait of the user. In some approaches, the gait data may be analyzed using the method described with reference to FIG. 9.

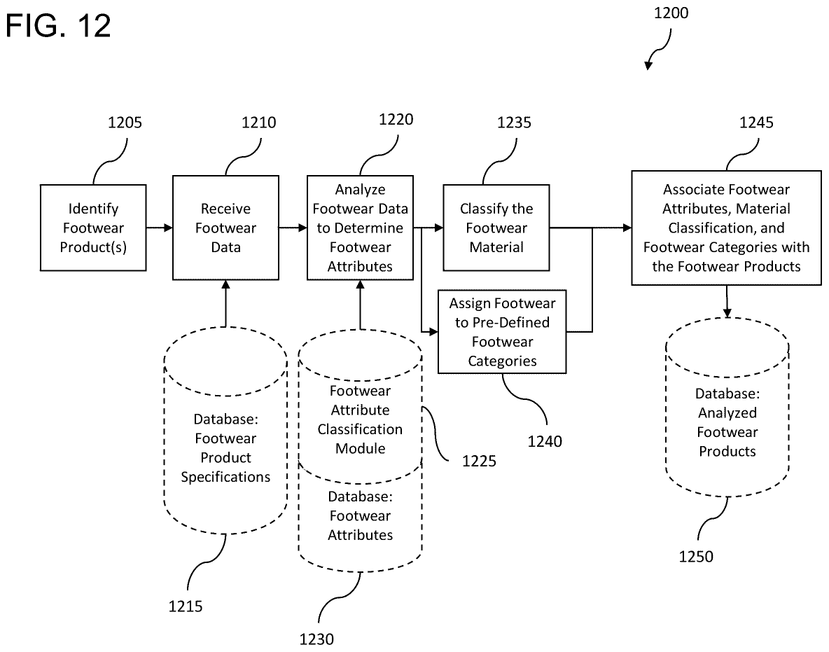

The footwear assessment involves collecting 220 and analyzing 225 footwear data associated one or more footwear products to determine one or more attributes of the footwear products. Such footwear data may include various forms of data such as image data, sensor data, test data, or product specifications. In some approaches, the footwear data may be collected via the method described with reference to FIG. 12. The footwear assessment further includes analyzing 225 the footwear data to determine one or more footwear attributes associated with a footwear product. Such footwear attributes may include one or more qualities, characteristics, or preferences associated with a footwear product that may impact footwear needs and fit. Footwear attributes may include footwear product specifications or properties such as product dimensions, geometry, material, material property, and style. In some approaches, the footwear data may be analyzed according to the method described with reference to FIG. 12.

The method 200 also includes determining 130 one or more footwear attributes associated with the user based on the personal gait and biomechanics attributes associated with the user. In some approaches, gait and biomechanics data may be analyzed to determine personalized footwear attributes via one or more modules associated with a system for providing personalized footwear, such as the system 300 described with reference to FIG. 3.

FIG. 3 illustrates an exemplary system 300 for providing personalized footwear in accordance with some embodiments. An exemplary data structure is illustrated in FIG. 3; however, it should be understood that other suitable data structures may be used by the system 300.

The components of system 300 may communicate directly or indirectly, such as over one or more distributed communication networks, such as network 380. For example, network 380 may include LAN, WAN, Internet, cellular, Wi-Fi, Bluetooth, and other such communication networks or combinations of two or more such networks. Various components of system 300 may also be hardwired.

It is contemplated that one or more processors may be associated with any of the components described in system 300. The term processor refers broadly to any microcontroller, computer, control-circuit, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The processor or may be configured (for example, by using corresponding programming stored in a memory as will be well understood by those skilled in the art) to carry out one or more of the methods, steps, actions, and/or functions described herein.

The system 300 may include one or more electronic user devices 350. The user devices may be configured to receive recommendations, prompts, queries, surveys, notifications, alerts, instructions, user input, or other information. The electronic user device may include, for example, a smart phone, a tablet, a laptop, a personal computer, a smart watch, etc.

One or more user interfaces 355 may be associated with the electronic user devices 350. The user interfaces may be used for user input and/or for output display. For example, the user interface may include any known input devices, such one or more buttons, knobs, selectors, switches, keys, touch input surfaces, audio input, and/or displays, etc. The user interfaces 355 may further include lights, visual indicators, display screens, etc. to convey information to a user, such as but not limited to the communication of: footwear recommendations; instructions regarding capturing images or video of a user's foot or gait; questions or requests for information regarding pathologies or contextual information associated with a user; prompts or instructions to indicate sensations associated with image of a user's foot; a sensation map illustrating sensations associated with an image of foot; notifications; prompts; errors, and/or other such information. Sensation maps may be either two dimensional or three dimensional. In this manner, the system may receive data or information regarding the foot shape, pathologies, gait, biomechanics, or contextual attributes associated with a user via a user interface.

The electronic user device may also be equipped with one or more sensors. The sensors may include one or more of an image sensor (e.g., a camera), a temperature sensor, a gyroscope, a light sensor, and a global positioning system (GPS) sensor. In some approaches, the image sensor may be able to record video at a frame rate of at least about 60 frames per second (fps), about 59.94 fps, about 50 fps, about 30 fps, or, in some aspects, about 24 fps. In some approaches, the image sensor may be able to record at a resolution of at least about 1440p, about 1080p, or, in some aspects, about 720p. Using an image sensor, such as a camera in an electronic user device, a user may capture one or more still images or pictures and/or one or more videos of the user's foot, limb, or portion thereof.

In one embodiment, the user may use one or more electronic user devices to complete a virtual footwear assessment by submitting at least one of the following: answers to a series of questions, one or more captured pictures of the user's feet, and one or more captured videos of the user's gait. In this manner, the user may be provided with recommendations for shoe models (with details on dimensions, materials, and other details), sizes for each model, and potential alterations to make each shoe a more suitable fit for the user. In an exemplary embodiment, one or more sensors and/or one or more cameras from the electronic user device may be utilized to acquire any necessary data (e.g., pictures, videos, etc.) from the user to make a personalized footwear recommendation or otherwise assess the footwear needs of a user.

The system 300 may also include various modules to provide personalized footwear or generate personalized footwear recommendations for a user. In some embodiments, the system 300 may include one or more of a foot shape module 302, a pathology module 304, a gait and biomechanics module 306, and a context module 308. These modules may be employed by system 300 to acquire raw data and to determine, assess, or otherwise extract personal attributes associated with a user based on the raw data. Personal attributes (e.g., foot shape attributes, pathology attributes, gait and biomechanics attributes, contextual attributes) may include a collection of an individual's personal qualities, characteristics, and product preferences that may influence calculated footwear fit and footwear personalization. For example, personal attributes may include: foot shape attributes such as 3D foot shape 3D foot dimensions, 2D foot shape, and 2D foot dimensions; foot pathology attributes such as pains, conditions, unobservable pathologies, observable pathologies, and other foot-related medical conditions; gait attributes such as gait patterns, measurements, and kinematics; biomechanics attributes such as foot plantar pressure patterns, measurements, and kinetics; and contextual attributes such as demographic, lifestyle, location, product preference, and style preference data.

The foot shape module 302 may be used to acquire and analyze data related to a user's foot shape. The foot shape module 302 may include one or more algorithms, such a machine learning algorithm, that may analyze various forms of data, including but not limited to image data, to determine one or more foot shape attributes associated with a user. Foot shape attributes may include 3D models, 3D characteristics and dimensions, 2D characteristics and dimensions, and other measurements of a foot, limb, or portions thereof that may be useful to determining a user's footwear needs. In some embodiments, the raw data acquired by foot shape module 302 and the foot shape attributes associated with a user (i.e., as determined by foot shape module 302) may be stored in a personal fit database 334. For example, foot shape attributes and raw data associated with a user may be associated with a user profile in personal fit database 334. The foot shape module 302 may operate in accordance with one or more of the methods described with reference to FIGS. 4 and 5. It is also contemplated that, one or more pre-determined foot shape measurements and/or foot shape attributes may be received by foot shape module 302. For example, one or more foot shape measurements or foot shape attributes may have been pre-determined (e.g., in medical evaluation or other evaluation method) and stored in one or more databases that may be communicable with foot shape module 302. In this manner, the pre-determined foot shape attributes may be received without the evaluation of video or image data by the foot shape module 302.

As shown in FIG. 3, the foot shape module 302 may include one or more model reconstruction algorithms 311. The model reconstruction algorithms 311 may construct models of a user's foot, limb, or portions thereof, for example, based on image data of a user's foot, limb, or portions thereof. In some approaches, the model reconstruction algorithm 311 may be a convolutional neural network (CNN) model trained for two-dimensional (2D) to three-dimensional (3D) model reconstruction. The foot shape module may also include a reference foot model database 309. The reference foot model database 309 may include sets of 3D foot models and associated photos. In some approaches, data in the reference foot model database 309 may be used to train the model reconstruction algorithm 311.

The foot shape module 302 may also include one or more foot shape classification algorithms 310. The foot shape classification algorithms 310 may be used to determine one or more foot shape attributes associated with a user, for example, based on image data of a user's foot, limb, or portions thereof. The foot shape classification algorithms 310 may be machine learning models trained to identify one or more foot shape attributes based on imaged data and/or 3D models of a user's foot, limb, or portions thereof. The foot shape module may further include a reference foot shape category database 312 that includes foot shape attributes based on populates with shared parameters (i.e., share 3D model, image data parameters).

In operation, the foot shape module 302 may analyze foot shape data to determine at least one foot shape attribute associated with a user. Using images of a user's foot, limb, or portions thereof, the foot shape module 302 may create high quality and accurate 3D models of the user's foot. Such 3D models may help to accurately capture the complex nature of the foot's shape. The foot shape module 302 may utilize machine learning, including but not limited to neural networks, and spatial computing. It is contemplated that one or more of machine learning algorithms, such as model reconstruction algorithm 311, or spatial computing may be applied to images to assess foot dimensions and morphology.

The pathology module 304 may be used to acquire and analyze data related to foot pathologies associated with a user. The pathology module 304 may include one or more algorithms, such a machine learning algorithm, that may analyze various forms of data, including but not limited to image data, to determine one or more foot pathology attributes associated with a user. Foot pathology attributes that may be determined using the foot pathology module may include observable foot pathologies and/or unobservable foot pathologies. In some embodiments, the raw data acquired by pathology module 304 and/or pathology attributes associated with a user (i.e., as determined by foot shape module 304) may be stored in the personal fit database 334. For example, pathology attributes and/or raw data associated with a user may be stored in a user profile in personal fit database 334.

As shown in FIG. 3, the pathology module 304 may include one or more observable pathology classification algorithms 313. The observable pathology classification algorithms 313 may include one or more machine learning models trained to identify observable foot pathologies based on image recognition. The pathology module 304 may further include one or more reference observable pathology databases 315. The reference observable pathology databases 315 may include reference image data of populations with observable foot pathologies. In some approaches, data in the reference observable pathology databases 315 may be used to train the observable pathology classification algorithms 313.

The pathology module 304 may also include one or more unobservable pathology classification algorithms 314. The unobservable pathology classification algorithms may include one or more machine learning models trained to identify unobservable foot pathologies based on image analysis. The pathology module 304 may further include one or more reference unobservable pathology databases 316. The reference unobservable pathology databases 316 may include reference image data of populations with observable foot pathologies. In some approaches, data in the reference observable pathology databases 316 may be used to train the observable pathology classification algorithms 314.

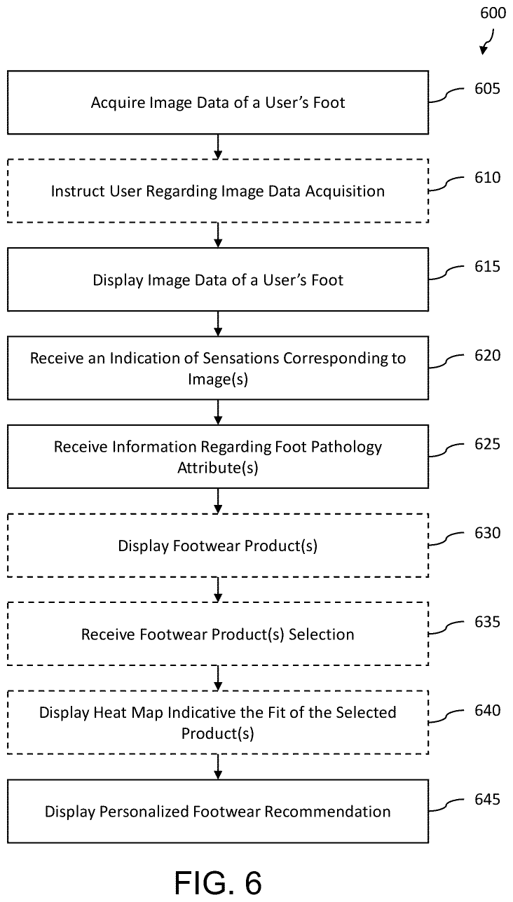

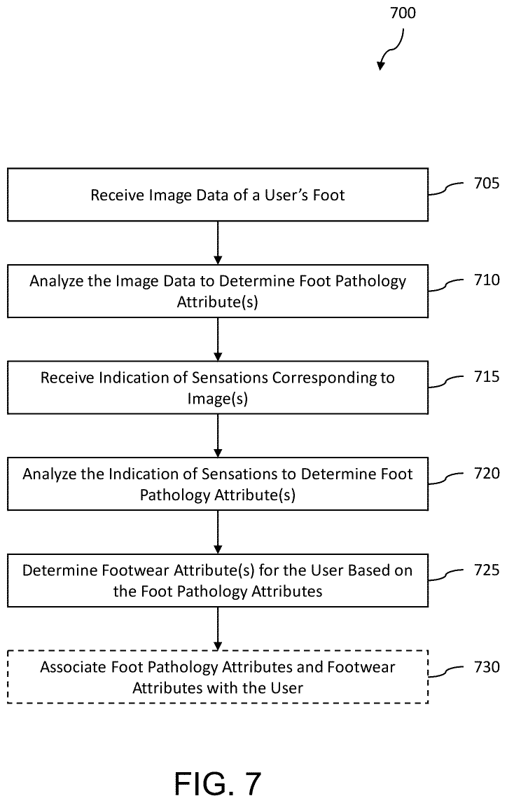

In operation, the pathology module 304 may receive data related to pathologies associated with a user. In some approaches, the pathology module 304 may acquire or otherwise receive data using an electronic user device. In one embodiment, the pathology module 304 may acquire and analyze the image data in accordance with one or more steps of the methods described with reference to FIGS. 6 and 7. In some approaches, the pathology module may identify pathology attributes that may influence a user's footwear needs. It is also contemplated that one or more pre-determined foot pathology attributes may be received by gait and biomechanics module 306. For example, one or more foot pathology attributes may have been pre-determined (e.g., in medical evaluation or other pathology evaluation method) and stored in one or more databases that may be communicable with pathology module 304. In this manner, the pre-determined foot pathology attributes may be received without the evaluation of video or image data by the pathology module 304.

The pathology module 304 may identify both observable and unobservable foot pathologies that may influence a user's footwear needs. In some approaches, the pathology module 304 may be configured to acquire or otherwise receive foot photos, sensation maps, and/or questionnaires. In one example, to acquire image data of a user's foot, the system 300 may prompt the user to take photos or video of the user's foot.

In some embodiments, image analysis may be applied by one or more processors associated with the foot pathology module 304. For example, image analysis may be applied to sensation maps to glean data on pains and sensitivities that correspond to specific foot conditions and pathologies, which ultimately influence personal footwear requirements. In an exemplary embodiment, the pathology module 304 may also analyze responses to surveys or questionnaires to glean data on pre-existing medical and/or foot conditions (e.g., diabetes, heel spur, shin splints, or other food condition), previous injuries (e.g., stress fractures, ankle sprains, or other types of foot and leg injuries), and medical procedures (e.g., metatarsal foot surgery, bunionectomy, or other types of foot and leg medical/surgical procedures).

The gait and biomechanics module 306 may be used to acquire and analyze data related to a user's gait and biomechanics. The gait and biomechanics module 306 may include one or more algorithms, such as machine learning algorithms, that may analyze various forms of data, including but not limited to image data or video data, to determine of or more gait and biomechanics attributes associated with a user. Gait attributes may include, for example, gait patterns, characteristics, measurements, and kinematics. Biomechanics attributes may include, for example, foot plantar pressure patterns, measurements, and kinetics. In some embodiments, the raw data acquired by gait and biomechanics module 306 and/or the gait attributes associated with a user (i.e., as determined by gait and biomechanics module 306) may be stored in a personal fit database 334. For example, gait attributes and raw data associated with a user may be associated with a user profile in personal fit database 334.

As shown in FIG. 3, the gait and biomechanics module 306 may include one or more gait classification algorithms 318 and may include one or more biomechanics algorithms 319. The gait classification algorithms 318 may determine gait attributes associated with a user based on, for example, image data and/or video data. In some approaches, the gait classification algorithm 318 may include a machine learning model trained for tracking a user's gait based on collection of gait video analyses and associated gait attributes. The gait module 306 may further include one or more reference gait databases 320. In some approaches, the reference gait databases 320 may include gait attributes based on populations with shared parameters. The biomechanics classification algorithms 319 may determine biomechanics attributes associated with a user based on, for example, pressure sensor data. In some approaches, the biomechanics classification algorithm 319 may include a machine learning model trained for tracking a user's gait based on collection of pressure map analyses and associated biomechanics attributes. The gait and biomechanics module 306 may further include one or more reference biomechanics databases 321. In some approaches, the reference biomechanics databases 321 may include biomechanics attributes based on populations with shared parameters.

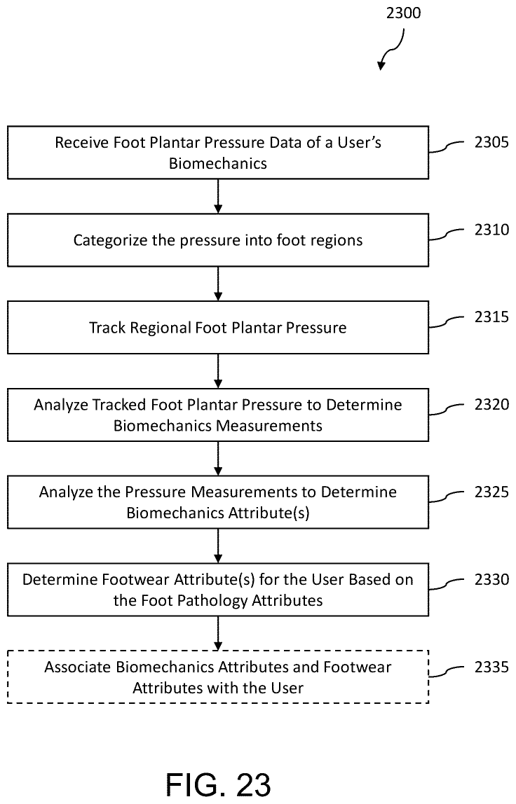

In operation, the gait and biomechanics module 306 may receive data related to the user's gait, such as image data and/or video data and user's biomechanics, such as foot plantar pressure. In one example, the gait and biomechanics module 306 may acquire and analyze the image data and/or video data to determine one or more gait attributes associated with the user in accordance with one or more steps of the methods described with reference to FIGS. 8 and 9. In some approaches, the gait and biomechanics module may identify gait attributes, such as gait patterns or characteristics, that may influence a user's footwear needs. In another example, the gait and biomechanics module 306 may acquire and analyze the foot plantar pressure data to determine one or more biomechanics attributes associated with the user in accordance with one or more steps of the methods described with reference to FIG. 23. It is also contemplated that one or more pre-determined gait and biomechanics attributes may be received by gait and biomechanics module 306. For example, one or more gait and biomechanics measurements or gait and biomechanics attributes may have been pre-determined (e.g., in medical evaluation or other gait evaluation or biomechanical evaluation method(s)) and stored in one or more databases that may be communicable with gait and biomechanics module 306. In this manner, the pre-determined gait and biomechanics attributes may be received without the evaluation of video or image data by the gait and biomechanics module 306.

The context module 308 may be used to acquire and analyze data related to contextual attributes associated with a user. Contextual attributes associated with a user may include, for example, data or information related to demographics, lifestyle, location, product preferences, and style preferences. In some embodiments, the raw data acquired by the contextual module 308 as well as contextual attributes associated with a user (i.e., as determined by context module 302) may be stored in a personal fit database 334. For example, contextual attributes and raw data associated with a user may be associated with a user profile in personal fit database 334.

As shown in FIG. 3, the context module 308 may include one or more of a demographics database 322, a lifestyle database 324, and a location database 326. The demographics database 322 may include data on key demographic factors known to be associated with specific foot characteristics. The lifestyle database 324 may include data on lifestyle factors that may impact a user's footwear. The location database 326 may include data on location related factors that may impact a user's footwear needs.

In operation, the context module 308 may receive data from a user, for example, through surveys or questionnaires related to demographics, product preferences, lifestyle, and location (i.e., the climate or setting in which the user will wear their footwear). The context module 308 may leverage data in one or more of the databases (i.e., demographics database 322, lifestyle database 324, and location database 326) to determine one or more contextual attributes associated with a user. For example, the context module 308 may use demographics database 322 to determine a personal contextual attribute associated with the user based on demographics data. The context module 308 may use lifestyle database 324 to determine a personal contextual attribute associated with the user based on lifestyle data. The context module 308 may use location database 326 to determine a personal contextual attribute associated with the user based on location data.

FIG. 3 illustrates an exemplary data structure for foot shape module 302, pathology module 304, gait and biomechanics module 306, and context module 308. However, it is contemplated that the system 300 may utilize alternative data structures to operate the foot shape module 302, pathology module 304, gait and biomechanics module 306, and context module 308. For example, any one of these modules may be communicable with any one of the databases illustrated in the system 300. In addition, while illustrated as separate modules, it is contemplated that a single engine, processor, server, or computing device may be employed to conduct each of the collection and analysis of the foot shape, pathology, gait, biomechanics, and contextual data. Additionally, although each of the modules and databases depicted in FIG. 3 are depicted as part of single system, it should be understood that any of the modules and/or database may be housed in separate system or on separate servers.

The system 300 may also include a personal attribute analysis module 328. The personal attribute analysis module 328 may analyze one or more personal attributes (i.e., foot shape attributes, pathology attributes, gait and biomechanics attributes, and/or contextual attributes) associated with a user to determine one or more footwear attributes to associate with the user. Footwear attributes may include any characteristic, feature, or product specification that may influence calculated footwear fit and/or footwear personalization. Footwear attributes may include, for example, information related to a footwear product's construction (e.g., design, seams, and dimensions), materials, materials properties (e.g., elasticity, stretchability, flexibility, breathability, waterproofing), style, appearance, assigned category, aesthetic descriptors, etc. It is also contemplated that footwear attributes may include characteristics, features, or product specifications that may influence the impact of a footwear product on skin or the interaction of multiple materials used in the footwear product. Footwear attributes may also include the history of accuracy of footwear size measurements provide by a supplier, retailer, or manufacturer.

The personal attribute analysis module 328 may include one or more classification algorithms. The classification algorithms may analyze personal attributes to determine one or more footwear attributes to associate with a user based on the user's personal attributes. In some approaches, the footwear classification algorithms may include one or more machine learning or CNN models to identify footwear attributes based on various inputs. Such inputs may include, but are not limited to, 3D models, foot shape attributes, pathology attributes, gait and biomechanics attributes, and/or contextual attributes. Inputs may further include any form of raw data input into system 300, such as image data, video data, context data, questionnaire responses, etc.

The system 300 may also include one or more prioritized footwear classification modules 330, which may include one or more classification algorithms. The prioritized footwear classification module 330 may include one or more machine learning models trained to identify footwear attributes associated with a user based on a user's personal attributes (i.e., foot shape attributes, pathology attributes, gait and biomechanics attributes, and/or contextual attributes). In this manner, the prioritized footwear classification module 330 may identify footwear attributes that are best suited for a user, based on the user's personal attributes. The prioritized footwear classification module 330 may be communicable with one or more attribute relationship databases 332. The attribute relationship database 332 may include data on relationships between various footwear attributes and personal attributes (i.e., foot shape attributes, pathology attributes, gait and biomechanics attributes, contextual attributes).

A footwear module 340 may also be included in system 300. The footwear module 340 may operate in accordance with the method described with reference to FIG. 12. The footwear module 340 may include one or more footwear classification algorithms 342. The footwear classification algorithms 342 may classify footwear product properties using a system of predefined footwear attributes. In some approaches, the footwear module 340 may further include a footwear attribute database 344. In some approaches, the footwear attribute database 344 may include a collection of predefined footwear attributes which may be used as descriptors to characterize footwear products. In operation, the footwear module 340 may associate one or more footwear attributes with a footwear product, for example, based on input data related to the footwear product. Such input data may come from a database; a sensor, scanner, an x-ray scanning device, a computed tomography scanning device, endoscopic probe, or other device for evaluating a footwear product; and/or from user inputs related to footwear product evaluation, inspection, and/or testing.

A footwear product specification database 346 may be communicable with footwear module 340. The footwear product specification database 346 may include footwear product specifications and may include data related to materials, construction, design, styles, aesthetic features, product reviews, and use cases associated with one or more footwear products. The data housed in footwear product specification database 346 may come from any one of a number of sources, including but not limited to, specifications provided by footwear product retailers, manufacturers, brands, and/or industry groups.

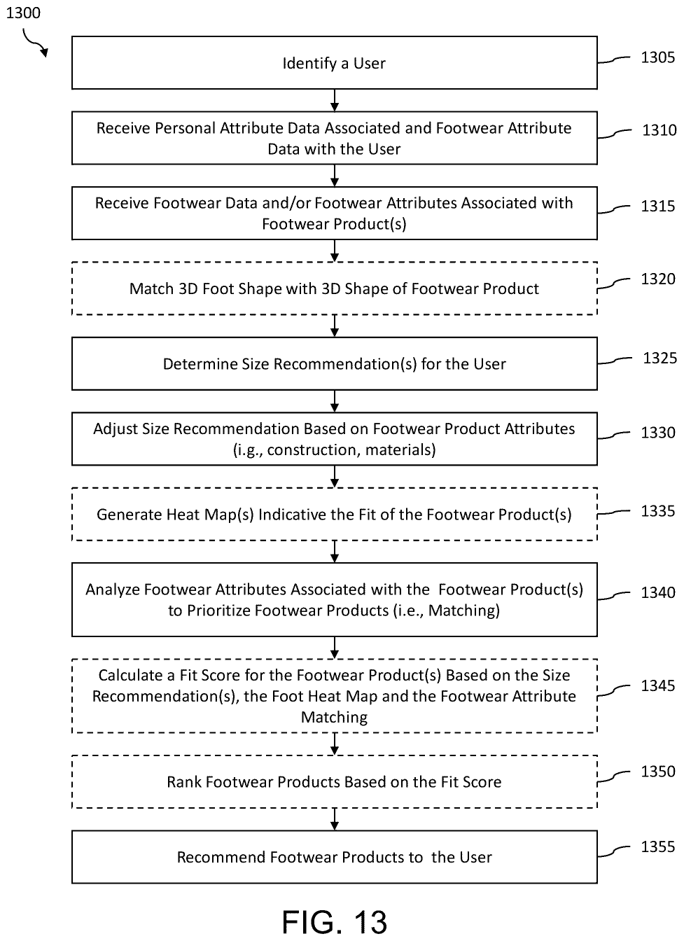

The system may further include a personalized footwear production and recommendation engine 336. The personalized footwear production and recommendation engine 336 may employ methods, such as those described with reference to FIG. 13, to utilize footwear attributes and personal attributes acquired and generated by the system 300. The personalized footwear production and recommendation engine 336 may merge (1) footwear product data and/or footwear attributes and (2) personal data and/or personal attributes to generate personalized footwear and personalized footwear recommendations. The personalized footwear production and recommendation engine 336 may generate specifications, size, style, materials, material properties (e.g., breathability, viscoelasticity, stretchability, tear strength, flexibility, water resistance, abrasion resistance, etc.), weight, tongue feature(s), lining feature(s), insole feature(s), toe box feature(s), outsole feature(s), upper feature(s), sole feature(s), heel height, degrees of foot support, construction (i.e., stitching, mesh), and/or product recommendations for a user. In some approaches, these recommendations may be sent to a user via an electronic user device.

It is also contemplated that the personalized footwear production and recommendation engine 336 may generate personalized footwear. For example, the personalized footwear production and recommendation engine 336 may send a signal to one or more manufacturing devices to control device operation. Manufacturing devices may include additive manufacturing devices 360 (such as 3D printing machines 2061 and/or 3D knitting machines 2063, etc), subtractive manufacturing devices 2065 (such as laser cutter and/or CNC machine, etc), and/or near net shape manufacturing devices 2067 (such as stamping, etc). Multiple manufacturing techniques can be utilized for product customization. One or a combination of manufacturing processes, including additive manufacturing (e.g., 3D printing 2061, 3D knitting 2063, welding), subtractive manufacturing 2065 (e.g., laser cutting, turning, drilling, milling) and/or near net shape manufacturing 2067 (e.g., stamping, casting, injection, blow molding, thermoforming) can support the production of custom-fitted footwear, including the shoe last and individual shoe product components. In some embodiments, the personalized footwear production and recommendation engine 336 may also be communicable with a manufacturing execution system to control one or more operational parameters for a footwear manufacturing process. It is contemplated that the footwear production engine 336 may control one or more manufacturing devices to manufacture a custom footwear product for a particular individual or user and/or to mass manufacture footwear products. In one approach, the engine 336 may operate a manufacturing device and/or process to control the features of a mass manufactured footwear product based one or more patterns identified by engine 336 in personal attributes (e.g., foot shape, pathology, gait, biomechanics, contextual) and/or footwear attributes.

The personalized footwear production and recommendation engine 336 may also provide one or more specifications to a computer-aided design (CAD) program 370. In some approaches, the personalized footwear production engine 336 may, for example, instruct a 3D printing machine to produce a portion of a shoe, such as, e.g., the sole, insole, and/or footbed and may instruct a 3D knitting machine to complete other portions of the shoe, such as, e.g., the upper and tongue. Furthermore, the personalized footwear production engine 336 also may subsequently instruct the 3D printing machine to produce additional portions of the shoe, such as, e.g., a toe cap.

In another embodiment, the personalized footwear and recommendation engine 336 may also be communicable with a shipping system. In one embodiment, the engine 336 may send a signal to the shipping system to automatically place an order for and/or ship one or more footwear products to a particular user and/or individual. In one example, the footwear product(s) could be shipped directly to the user. In another example, the footwear products could be shipped to a store or nearby location for pick-up. In another approach, the engine 336 may first identify one or more footwear products for a particular user and/or individual. In one approach, the user may select one or more of the identified footwear products to place an order and have the products shipped. In some embodiments, the engine 336 may both control the manufacturing of a footwear product for a particular user and automatically ship the product to the user. In this manner, the engine 336 may customize orders for a particular user. It is also contemplated that, after shipping or otherwise providing one or more custom footwear products to a user, the system 300 may also receive feedback on the footwear product(s). For example, the system 300 may transmit a questionnaire or survey to the user to receive information, for example, on the comfort, fit, aesthetics, or other experiences with the footwear product and for example, whether the user plans to keep the footwear product or would like certain adjustments to the product.

Described below, with reference to FIGS. 4-1 land 23 are various methods of operating the foot shape module, pathology module, gait and biomechanics module, and context module depicted in FIG. 3. These methods may be used, for example, to assess personal attributes associated with a user to provide personalized footwear and/or generate personalized footwear recommendations for the user. Personal attributes may assess one or more of the foot shape, pathologies, gait, biomechanics, and contextual information such as demographics, lifestyle, location, and/or product preferences of a user. Such personal attributes may implicate footwear product selection and may inform the selection of footwear products that best suit the fit, comfort, and preferences of the user. One or more of the modules may be operated together to gain a comprehensive understanding of the personal attributes associated with a user. As discussed above, one or more modules may be utilized to provide personalized footwear and/or generate personalized footwear recommendations for a user and no one module is required to execute the methods described herein.

Foot Shape Module

FIG. 4 illustrates an exemplary method 400 of acquiring and displaying foot shape data, in accordance with some embodiments. One or more electronic user devices, such as the electronic user devices described with reference to FIG. 3 may be used to carry out one or more steps of method 400. In some approaches, method 400 may be executed by or in conjunction with the foot shape module 302 described with reference to FIG. 3. One or more steps of method 400 may be used to acquire and display foot pathology data.

The method 400 includes acquiring 405 or otherwise receiving image data associated with a user's foot, limb, or portions thereof. The image data may include, for example, photos, images, and/or video. In some approaches, the image data may include three photos of an individual's foot from specific angles. The image data may be acquired or otherwise captured via an image sensor, such as a camera, associated with an electronic user device. In one example, a user may take three photographs of each foot using a camera to capture the following three views: top, inner, and outer. Image data may include any number of views, for example anywhere between 1 and 20, 1 and 10, and 1 and 5 views, and may also include other views such as front, rear, and bottom. In some approaches, the camera may provide augmented reality (AR) guides to ensure the proper positioning of the camera. It is also contemplated that method 400 is not limited to image data but may include acquiring other forms of data representative or indicative of a user's foot, limb, or portions thereof. It is also contemplated that image data may be acquired, for example, from one or more databases.

In some approaches, the image data may capture the user's foot in relation to another object, for example, a piece of standard letter paper. In one embodiment, a user will place his/her foot on a piece of standard letter paper to obtain one or more views.

The method 400 may also optionally include instructing 410 a user regarding the image data acquisition. In some approaches, instructions may be transmitted to user via a user interface associated with an electronic user device, for example, before or while a user is capturing image data. The prompt may instruct the user to take a specified number of photos, to take photos from a particular view or angle, to place a particular foot, limb, or portion thereof within the view of the image sensor, to adjust lighting, where to place a foot, limb, or portion thereof relative to another object, or to adjust the position of the electronic user device being used to acquire image data.

After acquiring image data, the method 400 may optionally include, displaying 415 the image of the user's foot, limb, or portion thereof to a user via the user interface. In some approaches, the image may be a 3D model of the user's foot generated, at least in part, based on the received image data.

The method 400 may also optionally include displaying 420 one or more footwear products, for example, via an electronic product catalogue. The user may view the footwear products through the user interface of the electronic user device. The product catalog may include various footwear products, models and/or styles. The method may further also optionally include receiving 425 an indication of a product selection. For example, a user may have the option to select one or more of the footwear products being viewed using a user interface of the electronic device. The user may then input a selection of a particular footwear product, model, and/or style.

In some embodiments, after receiving a selection, the user interface may optionally display 430 a heat map, showing “hot spots” that highlight areas where the selected footwear products, models, and/or styles are tight on the foot, loose on the foot, or may otherwise cause discomfort, irritation, or injury. One or more hot spots may be displayed on image data, for example, on a photo or 3D model, of the user's foot. In one approach, heat maps are generated by comparing a 3D model of the user's foot with a 3D model of a footwear product. For example, the heat map may depict the overlap between the outer surface of the user's foot and the footwear product. In some examples, different degrees of overlap may be depicted in different colors (e.g., 2 mm of overlap may be depicted in yellow while 5 mm of overlap may be depicted in red).

The user interface may also display 435 one or more personalized recommendations regarding one or more footwear product specifications based, at least in part, on the foot shape data. Recommendations may suggest one or more footwear products, sizes, styles, models, materials, material properties (e.g., breathability, viscoelasticity, stretchability, tear strength, flexibility, water resistance, abrasion resistance, etc.), weight, tongue feature(s), lining feature(s), insole feature(s), toe box feature(s), outsole feature(s), upper feature(s), sole feature(s), heel height, degrees of foot support, or other footwear attributes for the user.

FIG. 5 illustrates an exemplary method 500 of analyzing image data of a user's foot, limb, or portion thereof to determine one or more foot shape attributes associated with the user. In some embodiments, one or more steps of method 500 may be executed by or in conjunction with the foot shape module 302 described with reference to FIG. 3.

The method 500 includes receiving 505 image data of a user's foot, limb, or portion thereof. In some embodiments, the image data may include the image data acquired using the method described with reference to FIG. 4. For example, the image data may include image data of a user's foot, limb, or portion thereof from the following three views: top, inner, and outer. Image data may include any number of views, for example anywhere between 1 and 20, 1 and 10, and 1 and 5 views, and may also include other views such as front, rear, and bottom. The method then generates 510 a 3D model of the user's foot, limb or portion thereof based on the image data. In some approaches, at least one model reconstruction algorithm may be applied to the image data to generate the 3D model. In some approaches, the model construction algorithm may also extract at least one dimension of a user's foot, limb, or portions thereof from the image data and/or the 3D models. In some embodiments, the model reconstruction algorithm may be used to extract at least one foot dimension associated with the user's foot, limb, or portion thereof from the image data. In some approaches, the model reconstruction algorithm may be a CNN model trained 2D image to 3D model reconstruction. For example, the CNN model may be trained using reference sets of 3D models and associated photos from the three sets of views. In addition, the method 500 may further include determining at least one foot dimension in two dimensions using image processing, for example, based on foot layout on a sheet of paper (e.g., as captured in image data). Such dimensions may also be used to construct a 3D model of the user's foot or a portion thereof.

The method 500 may further include analyzing 520 the 3D models of the user's foot, limb, or portions thereof to determine at least one foot shape attribute associated with the user. In some embodiments, foot shape attributes may be determined by applying one or more foot shape classification algorithms to the 3D model and/or the image data. In some approaches, the foot shape classification algorithm may be a machine learning algorithm trained to identify one or more foot shape attributes based on the 3D model and/or the image data. In other embodiments, the foot shape attributes may be determined using spatial computing to assess at least one foot dimension or morphology associated with the user's foot, limb, or portion thereof using the image data.

Foot shape attributes may include any foot shape characteristics that may impact footwear. Foot shape attributes may include foot dimensions such as arch height, foot width, global foot width, midfoot width, foot length, ball width, inter-toe dimensions, ball circumference, ball angle, heel circumference, lateral metatarsal length, medial metatarsal length, arch length, instep height, and instep distance. Foot shape attributes may also include shape-related characteristics or morphologies such as hallux bone orientation, toe orientation, or foot type. By some approaches, at the foot shape attributes may include about 10, 8, 6, 4, or 2 dimensions that capture at least 75%, at least 85%, at least 90%, and in some instances about 92.6% of shape variation of the user's foot. In one example, foot shape attributes include 6 dimensions including arch height, combined ball width and inter-toe distance, global foot width, foot type, and midfoot width. In some embodiments, foot shape attributes may be determined by applying one or more foot shape classification algorithms to the 3D model and/or the image data. In some approaches, the foot shape classification algorithm may be a machine learning algorithm trained to identify one or more foot shape attributes based on the 3D model and/or the image data. In other embodiments, the foot shape attributes may be determined using spatial computing to assess at least one foot dimension or morphology associated with the user's foot, limb, or portion thereof using the image data to.

It is also contemplated that one or more foot shape measurements or foot shape attributes may be received from a database. For example, one or more foot shape measurements or foot shape attributes may have been pre-determined (e.g., in medical evaluation or other foot shape evaluation method). In this manner, the pre-determined foot shape measurements/or foot shape attributes may be received without the evaluation of video or image data. That is, steps 505-520 are not required to determine one or more foot shape measurements or foot shape attributes associated with a user.

The method 500 then includes determining 525 a footwear attribute to associate with the user based on at least one foot shape attribute. Footwear attributes associated with the user may include attributes of a footwear product best suited for the user based on the user's foot shape attribute. In one example, if a foot shape attribute of the user is a high arch, the footwear attribute associated with the user may be high arch support. In this manner, a recommendation may be generated for a user with a high arch, for example, suggesting a footwear product with high arch support. In another example, when a foot shape attribute associated with the user is a stacked toe or other digital deformity, the footwear attribute associated with the user may be materials with high elasticity. In this manner, a recommendation may be generated for a user with a digital deformity, for example, suggesting a footwear product comprised of a material having high elasticity. In some embodiments, classification algorithms may be used to identify at least one footwear attribute that is best suited the user based on the user's foot shape attributes. In some approaches, the classification algorithm may include a machine learning model trained to identify footwear attributes to associate with a user based on the user's foot shape attributes.

In some embodiments, the method 500 may include determining a footwear attribute to associate with the user using established relationships between various footwear attributes and various foot shape attributes. In one exemplary embodiment, relationships between footwear attributes and foot shape attributes may be quantified by giving a score, for example a score of 0-100, to a footwear attribute based on the foot shape attribute. A high score may indicate a strong preference for a specific parameter while a lower score indicates unsuitability for a specific parameter. The relationships between footwear attributes and foot shape attributes may be stored, for example, in a database.

The method 500 may optionally include associating 530 the foot shape attributes and/or footwear attributes with the user. In some approaches, the foot shape attributes and/or footwear may be associated with the user in a database, such as the exemplary personal fit database depicted in FIG. 3. For example, the database may include a user profile storing one or more foot shape attributes associated with the user. In some examples, the user profile may also store one or more footwear attributes associated with the user.

By acquiring and analyzing foot shape data in the manner described in FIGS. 4 and 5, the precise 3D characteristics of a user's foot, limb, or portions thereof may be captured and utilized to provide personalized footwear that is tailored to the user's foot shape.

Pathology Module

FIG. 6 illustrates an exemplary method 600 of acquiring and displaying foot pathology data, in accordance with some embodiments. One or more electronic user devices, such as the electronic user devices described with reference to FIG. 3 may be used to carry out one or more steps of method 600. In some approaches, method 600 may be executed in by or in conjunction with the pathology module 304 described with reference to FIG. 3. One or more steps of method 600 may be used to acquire and display foot pathology data.

The method 600 includes acquiring 605 or otherwise receiving image data associated with a user's foot, limb, or portions thereof. The image data may include, for example, photos, images, or video. The image data may be acquired or otherwise captured via an image sensor, such as a camera, associated with an electronic user device. In some approaches, the image data may include three photos of an individual's foot from specific angles. For example, a user may take three photographs of each foot using a camera capture the following three views: top, inner, and outer. Image data may include any number of views, for example anywhere between 1 and 20, 1 and 10, and 1 and 5 views, and may also include other views such as front, rear, and bottom. Image data may be acquired using a camera having feature that provides AR guides for the proper camera positioning. It is also contemplated that method 600 is not limited to image data but may include other forms of data representative or indicative of a user's foot, limb, or portions thereof. It is also contemplated that image data may be acquired, for example, from one or more databases.

The method 600 may also optionally include providing instructions 610 to a user regarding, for example, how to acquire image data. Instructions may be provided, for example, by sending a prompt to a user via a user interface associated with the electronic user device, for example, before or while a user is capturing image data. Instructions may instruct the user to take a specified number of photos, to take photos from a particular view or angle, to place a particular foot, limb, or portion thereof within the view of the image sensor, to adjust lighting, or to adjust the position of the electronic user device being used to acquire image data.

After acquiring image data, the method 600 may also include displaying 615 the image of the user's foot, limb, or portion thereof to a user via the user interface. In some approaches, the image may be a 3D model of the user's foot generated, at least in part, based on the received image data. The method 600 also includes receiving 620 an indication of one or more sensations associated with an image of the user's foot, limb, or portion thereof. In some embodiments, a user may map sensations onto one or more images by indicating areas experiencing one or more sensations. Sensation mapping may be performed using a user interface of an electronic user device. In one approach, a user may indicate sensations on one or more images by drawing on images of the user's foot, for example, using a stylus or finger on a touch screen of the electronic user device. In some embodiments, a user may select various colors or markings to indicate various sensations associated with a foot, limb, or portion thereof that is captured in the image. Sensations may include, for example, numbness, burning, aching, pins and needles, itching, soreness, throbbing, etc. It is also contemplated that a user may map or otherwise indicate one or more injuries, medical conditions, medical procedures, etc. on the image data.

The method 600 also includes receiving 625 information regarding one or more foot pathology attributes associated with the user. In some approaches, such information may be received from a database housing one or more previously determined foot pathology attributes. In other approaches, a questionnaire may be transmitted to the user to obtain information regarding one or more foot pathology attributes. In some approaches, the questionnaire may be transmitted to an electronic user device associated with the user and displayed via the user interface of the device. The questionnaire may include one or more questions, prompts, or requests for information related to pathology attributes associated with the user. The questionnaire may pertain to any foot pathology attributes including but not limited to, pre-existing medical and foot conditions, injuries, medical procedures that impact foot function and gait, foot biomechanics, history of foot injuries, history of limb injuries, history of foot medical procedures, history of lower-limb medical procedures, history of problems or successes with other shoes, and any other foot related-medical information. In response to receiving the questionnaire, a user may input information related to the queries, prompts, or requests for information via the user interface. The method may further optionally include associating the foot pathology attributes with the user. In some approaches, the foot pathology attributes may be associated with the user in a database, such as the exemplary personal fit database depicted in FIG. 3. For example, the database may include a user profile storing one or more foot pathology attributes associated with the user.

The method 600 may also optionally include displaying 630 one or more footwear products, for example, via an electronic product catalogue. The user may view the footwear products through a user interface of the electronic user device. The product catalog may include various footwear products, models and/or styles. The method may further also optionally include receiving 635 an indication of a footwear product selection. For example, a user may have the option to select one or more of the footwear products being viewed, for example, through a user interface of the electronic device. The user may input a selection of a particular footwear product, model, or style.

In some embodiments, after receiving a selection, the user interface may display 640 a heat map, showing “hot spots” that highlight areas where the selected footwear products, models, and/or styles are tight on the foot, loose on the foot, or may otherwise cause discomfort, irritation, or injury. One or more hot spots may be displayed on image data, such as a photo, or on a 3D model, of the user's foot.

The user interface may also display 640 one or more personalized recommendations regarding one or more footwear product specifications based, at least in part, on the pathology data. Recommendations may suggest one more footwear products, sizes, styles, models, materials, material properties (e.g., breathability, viscoelasticity, stretchability, tear strength, flexibility, water resistance, abrasion resistance, etc.), weight, tongue feature(s), lining feature(s), insole feature(s), toe box feature(s), outsole feature(s), upper feature(s), sole feature(s), heel height, degrees of foot support, construction (i.e., stitching, mesh), or other footwear attributes for the user.

FIG. 7 illustrates an exemplary method 700 of analyzing image data to determine foot pathology attributes associated with a user. In some embodiments, one or more steps of method 700 may be executed by or in conjunction with the pathology module 304 described with reference to FIG. 3.

The method 700 includes receiving 705 image data of a user's foot, limb, or portion thereof. In some embodiments, the image data may include image data acquired using the method described with reference to FIG. 4. For example, the image data may include image data of a user's foot, limb, or portion thereof from the following three views: top, inner, and outer. Image data may include any number of views, for example anywhere between 1 and 20, 1 and 10, and 1 and 5 views, and may also include other views such as front, rear, and bottom.

The method 700 then includes analyzing 710 the image data to determine at least one foot pathology attribute, such an observable foot pathology. Such observable foot pathologies may include digital deformities (e.g., hammertoe, claw toe, mallet toe, crossover toe), hallux valgus, tailor's bunion, blisters, or other general trauma. Observable pathologies may be automatically identified, for example, based on the image data of a user's foot, limb, or portion thereof. In some embodiments, an observable pathology classification algorithm is applied to the image data to identify one or more observable foot pathologies. In some approaches, the observable pathology classification algorithm may be a machine learning model trained to identify observable foot pathologies based on image recognition. In some instances, reference images of individuals with known observable foot pathologies may be used to train the machine learning model.

The method 700 also includes receiving 715 an indication of sensations corresponding to one or more images of a user's foot. In some embodiments, such an indication may be in the form of a sensation map, for example, the sensation map described with reference to FIG. 6. The method then includes analyzing 720 the indication of sensations to determine at least one foot pathology attribute, such as an unobservable foot pathology attribute. Unobservable foot pathology attributes may include, for example, central metatarsalgia, plantar fasciitis, heel spurs, and diabetic neuropathy. It is contemplated that, by receiving an indication of sensations corresponding to areas of a user's foot, for example, by mapping sensations to image data of the user's foot, it is possible to establish correlations between sensations and unobservable pathologies that may impact footwear needs. In some embodiments, at least one unobservable foot pathology may be determined by applying an unobservable pathology classification algorithm to a sensation map or to some other indication of sensations corresponding to an image of a user's foot. In some approaches, the unobservable pathology classification algorithm may include a machine learning model trained to identify unobservable foot pathologies based on image analysis. For example, the machine learning model may be trained using reference sensation maps of feet with known unobservable foot pathologies.

It is also contemplated that one or more foot pathology attributes may be received from a database. For example, one or more foot pathology attributes may have been pre-determined (e.g., in a medical assessment or other evaluation process). In this manner, the pre-determined foot pathology data and/or foot pathology attributes may be received without the evaluation of image data and/or questionnaires. That is, steps 705-720 are not required to determine one or more foot pathology attributes associated with a user.

The method 700 then includes determining 725 a footwear attribute to associate with the user based on at least one foot pathology attribute. Footwear attributes associated with the user may include attributes of a footwear product best suited for the user based on the user's foot pathology attributes. For example, if a foot pathology attribute of the user is a diabetic neuropathy, the footwear attribute associated with the user may be a closed-toe style. In this manner, a recommendation may be generated for a user with diabetic neuropathy, for example, suggesting a footwear product that is a closed-toe style. In another example, if a foot pathology attribute associated with the user is a bunion (hallux valgus), tailor's bunion, or other digital deformity, the footwear attribute associated with the user may be an upper with high elasticity and/or an upper that is seam free. In this manner, a recommendation may be generated for a user with a bunion (hallux valgus), tailor's bunion, or other digital deformity, for example, suggesting a footwear product with an upper with high elasticity and/or an upper that is seam free. In another example, if a foot pathology attribute associated with the user is hyperhydrosis, the footwear attribute associated with the user may be a material with high breathability. In this manner, a recommendation may be generated for a user with hyperhydrosis, for example, suggesting a footwear product with high breathability. In some embodiments, classification algorithms may be used to identify at least one footwear attribute that best suits the user based on the user's foot pathology attributes. In some approaches, the classification algorithm may include a machine learning model trained to identify footwear attributes to associate with a user based on the user's foot pathology attributes. In some embodiments, the method may determine a footwear attribute to associate with the user by using established relationships between various footwear attributes and various foot pathology attributes. In one exemplary embodiment, relationships between footwear attributes and foot pathology attributes may be quantified by giving a score, for example a score of 0-100, to a footwear attribute based on the foot pathology attribute. A high score may indicate a strong preference for a specific parameter while a lower score indicates unsuitability for a specific parameter. The relationships between footwear attributes and foot pathology attributes may be stored, for example, in a database.

The method 700 may optionally include associating 730 the foot pathology attributes and/or footwear attributes with the user. In some approaches, the foot pathology attributes and/or footwear may be associated with the user in a database, such as the exemplary personal fit database depicted in FIG. 3. For example, the database may include a user profile storing one or more foot pathology attributes associated with the user. In some examples, the user profile may also store one or more footwear attributes associated with the user.

By acquiring and analyzing pathology data in the manner described in FIGS. 6-7, observable and unobservable pathologies associated with a user's foot, limb, or portions thereof may be captured and utilized to provide personalized footwear that is tailored to the user's foot pathologies.

Gait Module

FIG. 8 illustrates an exemplary method 800 of acquiring and displaying gait data, in accordance with some embodiments. One or more electronic user devices, such as the electronic user devices described with reference to FIG. 3 may be used to carry out one or more steps of method 800. In some approaches, method 800 may be executed in by or in conjunction with the gait and biomechanics module 306 described with reference to FIG. 3. One or more steps of method 800 may be used to acquire and display gait and biomechanics data associated with a user.

The method 800 includes acquiring 805 or otherwise receiving video data associated with a user's gait. The video data may include, for example, video of the user walking. In some approaches, the video data may include two videos of the user walking, where the video is acquired from two specific views. The two specific views may be, for example, a frontal view and a side view. The video data may be acquired or otherwise captured via an image sensor, such as a camera, associated with an electronic user device. In some approaches, the video data may be markerless video data. It is also contemplated that method 800 is not limited to video data but may include other forms of data representative or indicative of a user's foot, limb, or portions thereof. It is also contemplated that video data may be acquired, for example, from one or more databases. Such data may be, for example, pre-recorded video or images or other pre-captured data indicative of a user's gait.

The method 800 may also optionally include providing instructions 810 to a user regarding, for example, how to acquire video data. Instructions may be provided, for example, by sending a prompt to a user via a user interface associated with the electronic user device, for example, before or while a user is capturing video data. Instructions may instruct the user (or an assistant to the user) to record video for a specified duration, to take video from a particular view or angle, to adjust the video background, to have the user take a specified number of steps or strides, to adjust the frame rate of the video capture, to adjust lighting, or to adjust the position of the electronic user device being used to acquire video data. After acquiring or otherwise receiving video data capturing the user's gait, the method may optionally include displaying 815 the video of the user's gait. For example, the video may be displayed on a user interface of an electronic user device.

After acquiring video data, the method may also optionally include displaying 820 one or more footwear products, for example, through an electronic product catalogue. The user may view the footwear products on the user interface of the electronic user device. The product catalog may include various footwear products, models and/or styles. A user may have the option to select one or more of the footwear products being viewed, for example, through a user interface of the electronic device. The user may then select a particular footwear product, model, or style.

The user interface may also display 825 one or more personalized recommendations regarding one or more footwear product specifications, based at least in part, on the gait and biomechanics data. Recommendations may suggest one more footwear products, sizes, styles, models, materials, material properties (e.g., breathability, viscoelasticity, stretchability, tear strength, flexibility, water resistance, abrasion resistance, etc.), weight, tongue feature(s), lining feature(s), insole feature(s), toe box feature(s), outsole feature(s), upper feature(s), sole feature(s), heel height, degrees of foot support, construction (i.e., stitching, mesh), or other footwear attributes for the user.

FIG. 9 illustrates an exemplary method 900 of performing a gait assessment, in accordance with some embodiments. In some embodiments, one or more steps of method 700 may be executed by or in conjunction with the gait and biomechanics module 306 described with reference to FIG. 3.

The method 900 includes receiving 905 video data of a user's gait. In some embodiments, the video data may include the image data acquired using the method described with reference to FIG. 8. For example, the video data may include a video of the user walking. In some approaches, the video data may include two videos of the user walking, where the video is acquired from two specific views. It is contemplated that the video data may be markerless video, in which no distinct object is placed on the region of interest (e.g., the limb or foot) for the purpose of being used for tracking. In some examples, anatomical features, personal features, skin tones, and deformities are excluded from being considered as intentional markers. The video data may then be parsed 910 into frames.

The method 900 further includes tracking 915 at least one limb of the user. For example, one or more points on a limb of the user may be tracked. Points that may be tracked may include one or more of a lateral knee condyle, a patella (i.e., knee-cap), a proximal tibia, a distal tibia, an ankle joint, an ankle joint including malleolus, a foot, a foot including navicular, and a toe. In some embodiments, tracking may be markerless, or tracked without the user of reference markers in the view of the video. In some approaches, tracking may be performed using one or more tracking-based machine learning algorithms to identify key points on a limb of the user. In some approaches, tracking involves tracking the motion of one or more points between frames of the video.

The method 900 may further include analyzing 920 tracked limbs to determine at least one gait attribute, such as a kinematic gait measurement. Kinematic gait measurements may include, for example, step time (i.e., time duration between ipsilateral and contralateral heel strike events), step length (i.e., horizontal distance traveled by heel between ipsilateral and contralateral heel strikes), gait speed (i.e., step length divided by step time), stance time (i.e., time between consecutive heel strike and toe off events), and stance swing (i.e., time between toe off and the consecutive heel strike event). Gait attributes may also include foot position, foot plantar flexion, ankle plantar flexion, joint loading, foot loading, and other lower-limb or foot kinetics. Tracked points on video frames may provide detailed information about gait. In some approaches, motion analysis may be applied to tracked points on video frames to assess gait.

The method 900 may also further include analyzing 925 kinematic gait measurements to determine at least one gait attribute. Gait attributes may include any gait categories, patterns, or characteristics which may inform a user's footwear needs. In some embodiments, kinematic gait measurements may be determined using one or more gait classification algorithms. In some approaches, the gait classification algorithms may include one or more machine learning models trained for tracking points based on one or more of gait video, gait patterns, gait measurements, and gait characteristics. In some examples, the machine learning model may be trained using reference gait data from populations with known gait parameters.

It is also contemplated that one or more gait measurements or gait attributes may be received from a database. For example, one or more gait measurements or gait attributes may have been pre-determined (e.g., in a gait lab or through another gait evaluation method). In this manner, the pre-determined gait attributes and/or gait attributes may be received without the evaluation of video or image data. That is, steps 905-925 are not required to determine one or more gait measurements or gait attributes associated with a user.

The method 900 may also include determining 930 a footwear attribute to associate with the user based on at least one gait attribute. Footwear attributes associated with the user may include attributes of a footwear product best suited for the user based on the user's gait attributes. For example, if a gait attribute of the user is under pronation, the footwear attribute associated with the user may be high arch support. In some examples, gait attributes such as heel strike, forefoot strike, or midfoot strike may implicate cushioning and/or sole thickness (i.e., footwear attributes). Accordingly, in some examples, for gait attributes like heel strike, forefoot strike, or midfoot strike, footwear attributes related to cushioning and/or sole strike may be associated with a user. In some embodiments, classification algorithms may be used to identify at least one footwear attribute that best suits the user based on the user's gait attributes. In some approaches, the classification algorithm may include a machine learning model trained to identify footwear attributes to associate with a user based on the user's gait attributes.

In some embodiments, the method 900 may determine a footwear attribute to associate with the user using established relationships between various footwear attributes and various gait attributes. In one exemplary embodiment, relationships between footwear attributes and gait attributes may be quantified by giving a score, for example a score of 0-100, to a footwear attribute based on the gait attribute. A high score may indicate a strong preference for a specific parameter while a lower score indicates unsuitability for a specific parameter. The relationships between footwear attributes and gait attributes may be stored, for example, in a database.

The method 900 may optionally include associating 935 the gait attributes and/or footwear attributes with the user. In some approaches, the gait attributes and/or footwear may be associated with the user in a database, such as the exemplary personal fit database depicted in FIG. 3. For example, the database may include a user profile storing one or more gait attributes associated with the user. In some examples, the user profile may also store one or more footwear attributes associated with the user.

By acquiring and analyzing gait data in the manner described in FIGS. 8 and 9, gait attributes associated with a user's foot, limb, or portions thereof may be captured and utilized to provide personalized footwear that is tailored to the user's gait.

FIG. 23 illustrates an exemplary method 2300 of performing a biomechanics assessment, in accordance with some embodiments. In some embodiments, one or more steps of the gait and biomechanics module 306 described with reference to FIG. 3 may be executed.

The method 2300 includes receiving 2305 foot plantar pressure data of a user. In some embodiments, the pressure data may include the pressure color map data and/or numerical pressure data acquired using the sensor. For example, the pressure data may correspond to a user standing or walking. In some approaches, the pressure data may include one or both feet of a user walking. It is contemplated that the pressure data may be in numerical, color map, and/or waveform and may be collected from one or more sensors or individual sensing units simultaneously. The pressure data may then be categorized 2310 into distinct foot regions which may include forefoot, midfoot, and backfoot and may be further categorized into medial and lateral aspects.

The method 2300 further includes tracking 2315 at least one region of the foot plantar pressure either in real time or after recording. For example, one or more points on a sensor on one or both feet of the user may be tracked. Points that may be tracked may one or more locations in one or more of the regions 2310 of the foot. In some embodiments, tracking will be assisted by the location of the sensing unit on the sensor. In some approaches, tracking may be performed using one or more tracking-based machine learning algorithms.

The method 2300 may further include analyzing 2320 tracked limbs to determine at least one biomechanics attribute, such as a foot plantar pressure measurement. Biomechanics attributes may also include foot position, foot plantar flexion, ankle plantar flexion, joint loading, foot loading, and other lower-limb or foot kinetics. In some approaches, motion analysis may be applied to tracked points on video frames to assess gait.

The method 2300 may also further include analyzing 2325 biomechanics pressure and/or other related measurements to determine at least one biomechanics attribute. Biomechanics attributes may include any biomechanics categories, patterns, or characteristics which may inform a user's footwear needs. In some embodiments, biomechanics measurements may be determined using one or more biomechanics classification algorithms. In some approaches, the biomechanics classification algorithms may include one or more machine learning models trained for tracking points based on one or more of pressure color maps, pressure values, sensor units, foot regions, and foot postures. In some examples, the machine learning model may be trained using reference biomechanics data from populations with known biomechanics parameters.

It is also contemplated that one or more biomechanics measurements or biomechanics attributes may be received from a database. For example, one or more biomechanics measurements or biomechanics attributes may have been pre-determined (e.g., in a biomechanics lab or through another biomechanics evaluation method). In this manner, the pre-determined biomechanics attributes and/or biomechanics attributes may be received without the evaluation of pressure sensor or other sensor data. That is, steps 2305-2325 are not required to determine one or more biomechanics measurements or biomechanics attributes associated with a user.

The method 2300 may also include determining 2330 a footwear attribute to associate with the user based on at least one biomechanics attribute. Footwear attributes associated with the user may include attributes of a footwear product best suited for the user based on the user's biomechanics attributes. For example, if a biomechanics attribute of the user is under pronation, the footwear attribute associated with the user may be high arch support. In some examples, biomechanics attributes such as heel strike, forefoot strike, or midfoot strike may implicate cushioning and/or sole thickness (i.e., footwear attributes). Accordingly, in some examples, for biomechanics attributes like heel strike, forefoot strike, or midfoot strike, footwear attributes related to cushioning and/or sole strike may be associated with a user. In some embodiments, classification algorithms may be used to identify at least one footwear attribute that best suits the user based on the user's biomechanics attributes. In some approaches, the classification algorithm may include a machine learning model trained to identify footwear attributes to associate with a user based on the user's biomechanics attributes.

In some embodiments, the method 2300 may determine a footwear attribute to associate with the user using established relationships between various footwear attributes and various biomechanics attributes. In one exemplary embodiment, relationships between footwear attributes and biomechanics attributes may be quantified by giving a score, for example a score of 0-100, to a footwear attribute based on the biomechanics attribute. A high score may indicate a strong preference for a specific parameter while a lower score indicates unsuitability for a specific parameter. The relationships between footwear attributes and biomechanics attributes may be stored, for example, in a database.

The method 2300 may optionally include associating 2335 the biomechanics attributes and/or footwear attributes with the user. In some approaches, the biomechanics attributes and/or footwear may be associated with the user in a database, such as the exemplary personal fit database depicted in FIG. 3. For example, the database may include a user profile storing one or more biomechanics attributes associated with the user. In some examples, the user profile may also store one or more footwear attributes associated with the user.

Context Module

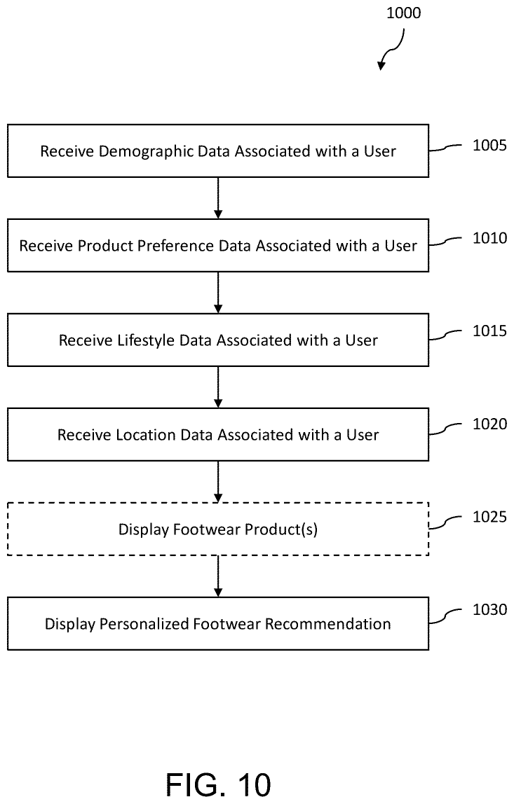

FIG. 10 illustrates an exemplary method 1000 of acquiring and displaying contextual data associated with a user, in accordance with some embodiments. The contextual data may include information regarding at least one personal contextual attribute associated with the user. Contextual attributes may include, for example, demographic information, product preference information, lifestyle information, location information, user footwear needs, and any other information that may impact the footwear needs of a user. One or more electronic user devices, such as the electronic user devices described with reference to FIG. 3 may be used to carry out one or more steps of method 1000. In some approaches, method 1000 may be executed in by or in conjunction with the context module 308 described with reference to FIG. 3. One or more steps of method 1000 may be used to acquire and display contextual data associated with a user.

The method 1000 includes receiving 1005 demographic data associated with a user. Demographic data may include information related to age, sex, gender, nationality, ethnicity, age, height, weight, body mass index (BMI) key variables known to be associated with specific foot characteristics (e.g., foot shape, bone structures, foot posture (including pronation/supination), and foot deformities (including digital deformities), or any other demographic factors that may impact footwear needs. In one example, a high BMI may be associated with increased ankle width, increased Achilles' tendon width, increased heel width, and a thicker forefoot along the dorsoplantar axis. In another example, age may be associated with heel width, Achilles' tendon width, toe height, and hallux orientation.

The method 1000 also includes receiving 1010 footwear preference data associated with a user. Footwear preference data may include information related to footwear style, color, brand, material, or any other factors that may impact footwear selection, design, or recommendations for a user. In one example, a user may provide information on the footwear category the user is interested in or their style preference(s). Footwear product categories may include but are not limited to: athletic shoes, casual walking shoes, boat shoes, boots/booties, clogs/mules, fashion sneakers, flats, heels, loafers, oxfords/derbys, sandals, and slippers. Style preferences may be based on footwear type and category. For style preferences, a user may be presented with a collection of images of products of that type/category that represent a broad range of style. A user may be prompted to select one or more images that match their personal style and fashion preference.

The method 1000 also includes receiving 1015 lifestyle data associated with a user. Lifestyle data may include information related to activity level, frequency of various activities, profession, social interests, hobbies, interests, sports, exercise classes, or other lifestyle factors that may impact footwear needs. In some approaches, a user may be prompted to provide information on their lifestyle, including physical activity levels or average daily step count, which may impact footwear construction, material, and durability requirements. Certain lifestyle information may be useful contextual information for assessing footwear needs and providing appropriate recommendations and fit for a user. For example, the frequency of sport activity has been associated with Achilles' tendon width and toe height. It is also contemplated that lifestyle information may be automatically received from one or more biometric sensors associated with the user. Biometric sensors may be present, for example, in a smart watch, fitness tracker, or electronic user device.

The method 1000 further includes receiving 1020 location data associated with a user. Location data may include information related to a country, city, state, county, geographic region, climate, address, zip code, or any other location-related factors that may impact a user's footwear needs. In an exemplary embodiment, the user be prompted to provide location information, such as, their residence zip code. The climate where a user resides, for example, may impact their footwear breathability and/or waterproofing requirements. It is also contemplated that location data may be automatically received from one or more sensors, such as a GPS sensor associated with a user.

It is contemplated that steps 1005-1020 may be accomplished by transmitting one or more questionnaires to a user, the questionnaires may pertain to one or more of the categories of contextual data (i.e., demographic, product preference, lifestyle, location, etc.). The questionnaire may be transmitted to an electronic user device associated with the user and displayed via the user interface of the device. The questionnaire may include one or more questions, prompts, or requests for information related to demographic information, footwear categories the user is seeking, footwear preferences, lifestyle information, and location information associated with the user. In response to receiving the questionnaire, a user may input information related to the queries, prompts, or requests for information via the user interface. In some approaches, the information may be in the form of responses or answers to the questions, prompts, or requests for information included in the questionnaire.

It is also contemplated that, one or more of demographic information, product preference information, lifestyle information, location information, or user footwear needs, or may be received from a database. For example, one or more gait measurements or gait attributes may have been pre-determined (e.g., in previous survey or personal evaluation). In this manner, the pre-determined information may be received without a questionnaire.

The method may also optionally include displaying 1025 one or more footwear products, for example, through an electronic product catalogue. The user may view the footwear products on a user interface of the electronic user device. The product catalog may include various footwear products, models and/or styles. A user may have the option to select one or more of the footwear products being viewed, for example, through a user interface of the electronic device. The user may then select a particular footwear product, model, or style.

The user interface may also display 1030 one or more personalized recommendations regarding one or more footwear product specifications, based at least in part, on the contextual data. Recommendations may suggest one more footwear products, sizes, styles, models, materials, material properties (e.g., breathability, viscoelasticity, stretchability, tear strength, flexibility, water resistance, abrasion resistance, etc.), weight, tongue feature(s), lining feature(s), insole feature(s), toe box feature(s), outsole feature(s), upper feature(s), sole feature(s), heel height, degrees of foot support, construction (i.e., stitching, mesh), construction (i.e., stitching, mesh), or other footwear attributes for the user.

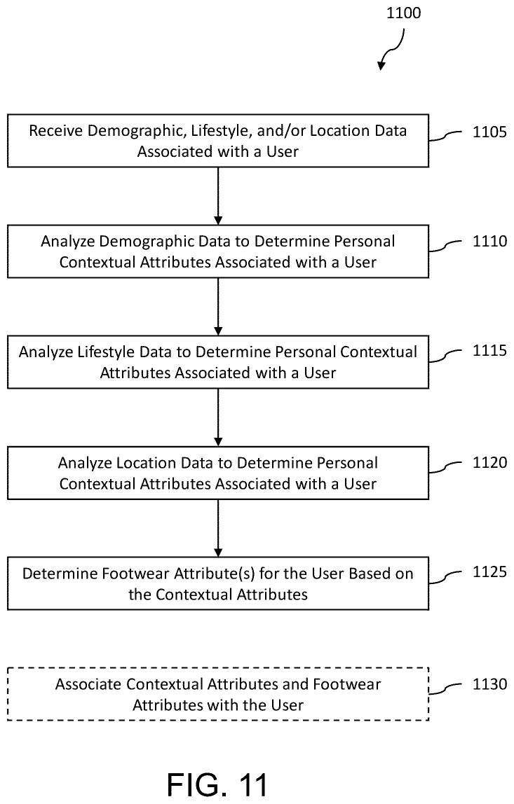

FIG. 11 is a flow diagram of a method 1100 of analyzing contextual data, in accordance with some embodiments. In some embodiments, method 1100 may be executed by or in conjunction with the context module described with reference to FIG. 3.

The method 1100 may include receiving 1105 contextual data associated with a user, such contextual data may include demographic, lifestyle, and/or location data associated with the user. In some approaches, the contextual data may be received in accordance with method 1000, which is described with reference to FIG. 10. It is contemplated that one or more steps in method 1000 may be executed in conjunction with method 1100. In one example, the contextual data may be received in the form of responses to a questionnaire completed by the user, in which the user is prompted to provide one or more of demographic, lifestyle, and location data.

The method 1100 may further include analyzing 1110 demographic data to determine at least one contextual attribute associated with the user. Personal contextual attributes may include any personal attributes, features, or characteristics that are related to or impacted by contextual data such as demographics, lifestyle, or location. In some approaches, the demographic data may be analyzed by a computational engine, such as the personalized footwear production and recommendation engine 336 described with reference to FIG. 3. The computational engine may access a database housing reference demographic data to determine one or more contextual attributes to associate with the user based on the demographic data. The reference demographic data may include data on key contextual attributes known to be associated with specific demographic factors. Personal contextual attributes such as ankle width, Achilles' tendon width, heel width, forefoot thickness along the dorsoplantar axis, hallux orientation, and hallux varus may be associated with demographic data such as BMI results, age, or sex. Accordingly, one or more personal contextual attributes may be determined based on demographic data associated with a user, for example, by leveraging known relationships between personal contextual attributes and demographic factors. In some approaches, statistical analysis may be applied to demographic data to extract demographic-related contextual attributes associated with the user.

In one example, higher BMI may result in increased ankle width, Achilles' tendon width, heel width, and a thicker forefoot along the dorsoplantar axis. Accordingly, a user may be determined to have increased ankle width, Achilles' tendon width, heel width, or a thicker forefoot along the dorsoplantar axis when demographic data indicates the user has a high BMI. In another example, age may be related to Achilles' tendon width, heel width, toe height, and hallux orientation. Accordingly, a user may be determined to have particular Achilles' tendon width, heel width, toe height, and hallux orientation attributes when demographic data provides information on the user's age. In another example, sex may be related to ankle width, Achilles' tendon weight, and heel width. Accordingly, a user may be determined to have particular to ankle width, Achilles' tendon weight, and heel width attributes when demographic data provides information on the user's sex.

The method 1100 may also include analyzing 1115 lifestyle data to determine at least one contextual attribute associated with a user. In some approaches, the demographic data may be analyzed by a computational engine, such as the personalized footwear production and recommendation engine 336 described with reference to FIG. 3. The computational engine may access a database housing reference lifestyle data to determine one or more contextual attributes to associate with the user based on the lifestyle data. The reference lifestyle data may include data on key contextual attributes known to be associated with specific lifestyle factors. Personal contextual attributes such as ankle width, Achilles' tendon width and toe width may be associated with the frequency of physical activity levels, such as the frequency of sport related activity. Accordingly, one or more personal contextual attributes may be determined based on lifestyle data associated with a user, for example, by leveraging known relationships between personal contextual attributes and lifestyle factors. In some approaches, statistical analysis may be applied to lifestyle data to extract demographic-related contextual attributes associated with the user.

The method 1100 may further include analyzing 1120 location data to determine at least one contextual attribute associated with a user. In some approaches, the location data may be analyzed by a computational engine, such as the personalized footwear production and recommendation engine 336 described with reference to FIG. 3. The computational engine may access a database housing reference location data to determine one or more contextual attributes to associate with the user based on the location data. The reference location data may include data on key contextual attributes known to be associated with specific location factors. Personal contextual attributes such as preferences for footwear material, material breathability, style, and waterproofing may be associated with the climate. Accordingly, one or more personal contextual attributes may be determined based on location data associated with a user, for example, by leveraging known relationships between personal contextual attributes and location factors. In some approaches, statistical analysis may be applied to location data to extract demographic-related contextual attributes associated with the user.

It is also contemplated that one or more contextual attributes may be received from a database. For example, one or more pieces of contextual data and/or contextual attributes may have been pre-determined (e.g., in previous survey or personal evaluation). In this manner, the pre-determined information or attributes may be received. That is, steps 1105-1120 are not required to determine one or more contextual attributes associated with a user.

The method may also include determining 1125 a footwear attribute associated with the user based on at least one contextual attribute. Footwear attributes associated with the user may include attributes of a footwear product best suited for the user based on the user's contextual attributes. In some embodiments, classification algorithms may be used to identify at least one footwear attribute that best suits the user based on the user's contextual attributes. In some approaches, the classification algorithm may include a machine learning model trained to identify footwear attributes to associate with a user based on the user's contextual attributes. The method may determine a footwear attribute to associate with the user using established relationships between various footwear attributes and various contextual attributes. In one exemplary embodiment, relationships between footwear attributes and contextual attributes may be quantified by giving a score, for example a score of 0-100, to a footwear attribute based on the contextual attribute. A high score may indicate a strong preference for a specific parameter while a lower score indicates unsuitability for a specific parameter. The relationships between footwear attributes and contextual attributes may be stored, for example, in a database that may be accessed by the context module.

The method may optionally include associating 1130 the contextual attributes and/or footwear attributes with the user. In some approaches, the contextual attributes and/or footwear attributes may be associated with the user in a database, such as the exemplary personal fit database depicted in FIG. 3. For example, the database may include a user profile storing one or more contextual attributes associated with the user. In some examples, the user profile may also store one or more footwear attributes associated with the user.

Footwear Module

In addition to assessing personal attributes associated with a user to provide personalized footwear, the approaches described herein may also assess footwear attributes associated with one or more footwear products. The approaches described herein may assess footwear attributes related to product size and dimensions, it is also contemplated that the approaches may assess a footwear product's construction, materials, and material properties. Aspects of footwear like construction and materials may have an impact, for example, based on an individual's foot pathologies, gait, biomechanics, and personal comfort. Accordingly, the approaches described herein may involve comprehensive analysis of footwear products to determine a variety of footwear attributes, beyond only size and dimensions, that may impact the footwear needs of a user.

Turning to FIG. 12, FIG. 12 illustrates an exemplary method 1200 of acquiring and analyzing footwear data to determine attributes associated with one or more footwear products. Footwear data and footwear attributes may relate to one or more of geometry, construction, materials, material properties, style, design, or aesthetic appearance of a footwear product. For example, footwear attributes may include any property, characteristic, feature, or specification that may be associated with a footwear product. Exemplary footwear attributes may be related to one more geometry, construction, materials, and material properties of a footwear product. In some approaches, the footwear attributes may be predefined attributes, for example, that are stored in a database. Accordingly, method 1200 may be used to assess one or more footwear products and assign one or more predefined footwear attributes to the footwear product(s) based on the assessment.

The method 1200 may optionally begin by identifying 1205 one or more footwear products. Footwear products may be identified for example by receiving an identifier associated with a particular footwear product. In some approaches, the unique identifier may be a product SKU used by a retailer, manufacturer, or other business. In other approaches, the unique identifier may be an identifier associated with a footwear product, for example, as part of a footwear profile. In one embodiment, a user may enter an identifier via an input device. In another example, the identifier may, for example, be encoded in a magnetic stripe, machine-readable symbol, or wireless transponder (e.g., RFID transponder) present on or otherwise associated with the footwear product. By identifying a footwear product in this manner, footwear data or any other footwear attributes acquired or determined as part of method 1200 may be associated with or otherwise linked to the identified footwear product.

The method 1200 also includes receiving footwear 1210 data. Footwear data may be in various forms and may be received from various sources. In one approach, footwear data may be received from one or more databases. In one example, footwear data is received from a database that houses footwear product specifications for at least one footwear product, such as database 1215. Product specifications may include information related to the construction, dimensions, materials, and/or material properties of a footwear product. It is also contemplated that product specifications may relate to the style, design, or aesthetic appearance of a footwear product. Information related to construction may include details related to the upper construction, heel notch, heel tab, toe cap, or sole of the footwear product and may provide information such as a number of layers are present, types of layers present, and types of materials included in the construction of the footwear product. Information related to materials may include information on the types of materials (e.g., leather; synthetics such as polyurethane leather or synthetic leather; textiles such as cotton, nylon, polyester, or wool; foams such as open cell or closed cell polyurethanes, EVA, polyethylene, neoprene, or latex; rubber; etc.) used in the footwear product. Information related to geometry may include exterior 3D shape, 2D shape, dimensions, and measurements and interior 3D shape, 2D shape, dimensions, and measurements (e.g., both with and without the insole present).

In other approaches, a user may input or otherwise provide footwear data, for example, via an electronic user device. For example, a user may conduct a physical assessment, inspection, or testing of a footwear product and input various parameters and information gleaned from such an assessment, inspection, or testing. A user may input various parameters or other information, for example, via a user interface of an electronic user device. In one example, a user may acquire or capture footwear data by taking physical measurements of a footwear product. In another example, a user may conduct testing on a footwear product to determine quantitative or qualitative properties of a material in the footwear product. In another example, a user may acquire an image or video of a footwear product using an image sensor such as a camera. It is also contemplated that footwear data may be received directly from one or more sensors, 3D scanners, endoscopic probes, or other suitable measurement devices. For example, a 3D scanner or endoscopic probe may be used to scan, analyze, or otherwise measure a footwear product. Footwear data may be received either directly or indirectly from such sensors, 3D scanners, endoscopic probes, or other measurement devices.

In another approach, footwear data may be received from one or more electronic models or drawing files, such as a computer-aided design (CAD) models or drawing file, associated with a footwear product. It is contemplated that information pertaining to geometry, construction, and materials may be received either directly or indirectly from such drawing files.

Method 1200 may also include analyzing 1220 the footwear data to determine one or more footwear attributes associated with the footwear product. A footwear product may be further classified by footwear attributes based on the footwear data. In some embodiments, footwear data may be analyzed using one or more footwear classification algorithms. In some approaches, the footwear classification algorithms may be included in a footwear attribute classification module 1225. Such footwear attribute classification algorithms may assign footwear attributes to a footwear product, based at least in part on the received footwear data. Footwear classification algorithms may access one or more footwear attribute databases, such as database 1230. A footwear attribute database may include a collection of predefined footwear attributes such as product descriptors including, materials, constructions, and preferred uses which have been analyzed or defined for the purpose of providing personalized footwear.

In addition, method 1200 may include classifying 1235 one or more footwear materials. Material classification may utilize or employ models from mechanical and/or engineering sciences which may include, for example, linear elastic, non-linear elastic (e.g., hyperelastic, hypoelastic), viscoelastic (e.g., elastomer), and/or thermoelastic materials. The method 1200 may further include assigning 1240 the footwear product to one or more pre-defined footwear categories. Footwear construction may include, for example, stitching methods, adhesives (i.e., glue), and/or combination of materials. In one exemplary embodiment, footwear models may be classified according to their shape, material, construction, and preferred daily use. Classification may be achieved by giving a score, for example a score of 0-100, to a footwear product based on the shape, material, construction, and/or preferred daily use. A high score may indicate a strong preference for a specific parameter while a lower score indicates unsuitability for a specific parameter. In some approaches, a footwear product may be assigned to a pre-defined footwear category based, at least in part, on the footwear data and/or footwear attributes. In some examples, the pre-defined footwear categories may be categories related to footwear construction.

Finally, footwear attributes, material classifications, footwear categories, and/or footwear data captured via method 1200 may be associated 1245 with the footwear products. In one example, footwear attributes may be associated with a product, for example, in a database such as the analyzed footwear product database 1250. In some approaches, the footwear attributes, material classifications, footwear categories, and/or footwear data may be associated with a footwear profile in one or more databases.

Personalized Footwear Production and Recommendation Engine

In some approaches, the personal attributes (i.e., foot shape, pathology, gait, biomechanics, and contextual attributes) and footwear attributes described herein may be used to provide personalized footwear and/or generate personalized footwear recommendations.

FIG. 13 illustrates an exemplary method 1300 of providing personalized footwear and/or generating personalized footwear recommendations, in accordance with some embodiments. It is contemplated that method 1300 may be executed by the personalized footwear production and recommendation engine 336 described with reference to FIG. 3. Such a footwear recommendation engine 336, for example, may be based on one or more of trained machine learning models and mathematical computations applied on input and/or output of the machine learning model.

Method 1300 may include identifying 1305 at least one user. For example, the user may be an individual that for whom the personalized footwear or footwear recommendations are to be provided. A user may be identified, for example, by receiving a user identifier associated with the user. In some approaches, the user identifier may be associated with one or more footwear attributes and and/or personal attributes (e.g., foot shape, pathology, gait, biomechanics, contextual attributes), for example, as part of a user account or profile. In some examples, a user may enter a user identifier via an input device. In another example, a user identifier may be associated with a user's mobile or wearable device and may be automatically received when a user's mobile or wearable device is recognized via a wireless network (e.g., a Wi-Fi or Bluetooth (BLE) network).

Method 1300 may also include receiving 1305 data representing one or more personal attributes (e.g., foot shape, pathology, gait, biomechanics, contextual attributes) and one or more footwear attributes associated with the user. In some approaches, the personal attributes (e.g., foot shape, pathology, gait, biomechanics, contextual attributes) and footwear attributes associated with the user may be received from one or more databases. In one embodiment, the personal attributes (e.g., foot shape, pathology, gait, biomechanics, contextual attributes) and footwear attributes associated with the user may be received from the personal fit database described with reference to FIG. 3. The personal fit database, for example, may house the personal attributes (e.g., foot shape, pathology, gait, biomechanics, contextual attributes) and footwear attributes acquired via the foot shape, pathology, gait, biomechanics, and contextual modules.

In addition, the method 1300 may include receiving 1310 footwear data and/or footwear attributes associated with one or more footwear products. In some approaches, the footwear attributes may be received from one or more databases. In one embodiment, the footwear data and/or footwear attributes may be received from the analyzed footwear database described with reference to FIG. 3. The analyzed footwear product database may house the footwear data and/or footwear attributes acquired via the footwear module.

The method may also optionally include providing a compatibility score or matching 1315 a 3D foot shape (i.e., the outer surface of a user's 3D foot model) of the user with the 3D shape of a footwear product (i.e., the interior surface of a footwear product's interior).

The method may include determining 1320 a footwear product size recommendation for the user based on one or more of: (1) the personal attributes and footwear attributes associated with the user; and (2) the footwear attributes associated with a footwear product. The method may also include adjusting 1325 a size recommendation based on footwear attributes associated with the footwear product. Such adjustments may adjust sizing by accommodating for a footwear product's construction, materials, and/or material properties. In some embodiments, sizing may be adjusted based on relationships between footwear attributes and various personal attributes such as foot shape, pathology, gait, biomechanics, and/or contextual attributes. In some approaches, relationships between footwear attributes and various personal attributes such as foot shape, pathology, gait, biomechanics, and/or contextual attributes may be stored in a n Attribute Database.

The method may optionally include generating 1330 one or more heat maps indicative of the fit of a footwear product. Heat maps may be generated for one or more footwear products. In some approaches, heat maps may provide an indication of one or more areas of possible discomfort, for example, on an image or 3D model of the user's foot. In some approaches, possible areas of discomfort may be identified based on the foot pathology attributes associated with the user, such as observable or unobservable foot pathologies. Heat maps may also incorporate hot spots or otherwise indicate areas where a footwear product may be loose or tight on a user based on, for example, the foot shape analysis performed by the footwear module.

The method may also include analyzing 1335 the footwear attributes associated with footwear products to match footwear products with the user. This matching process may be done by comparing the foot attributes associated with the user to the footwear attributes associated with a footwear product. In this manner, footwear products may be prioritized based on the number of matching footwear attributes between a user and a footwear product. By some approaches, to prioritize footwear products, the footwear attributes associated with a user may be compared to the footwear attributes associated with various footwear products. In some approaches, footwear products matching the greatest number of a user's footwear attributes will be prioritized. In one example, a footwear attribute match level will be calculated to determine the level of overlap between the footwear attributes of a footwear product and the footwear attributes associated with a user.

The method may further optionally include calculating 1340 a fit score for one or more footwear products based on one or more of the size recommendations, the foot heat maps, and the footwear attribute match level. In some approaches, the fit score calculated based on one or more of the scores assigned to various footwear attributes in method 500 (i.e., by the Foot Shape module), method 700 (i.e., the Pathology Module), method 900 (i.e., the Gait Module), and method 1100 (i.e., the contextual module). It is contemplated that the fit score may take into consideration one or more of the following factors provided in Table 1.

TABLE 1

| Factor | Description |
|---|---|
| Footwear Attribute | May consider the influence of 3D foot shape |
| Relationship with Foot | by shoe material properties and how footwear |
| Shape Attributes | attributes interact with foot surface |
| | morphologies |
| Footwear Attribute | May consider interaction of footwear material |
| Relationship with Foot | with the foot pathologies, including predicting |
| Pathology Attributes | long term effect of a material, shoe |
| | construction, and design on specific |
| | pathology |
| Footwear Attribute | May consider the effect of material and |
| Relationship with Gait | construction on a user's walking pattern, foot |
| and Biomechanics | posture, foot plantar pressure, and activity |
| Attributes | level |
| Footwear Attribute | May consider footwear category, style, and |
| Relationship with | use case |
| Contextual Attributes | |

In one embodiment of a footwear scoring system, scoring may be based on one or more of the following factors presented in Table 2.

TABLE 2

| Variable | Description |
|---|---|
| Footwear Design (FD) | 3D geometry, including shape and volume, of |
| | a footwear |
| Footwear Material | Material properties of the footwear (e.g., |
| (FM) | stretch, cushioning, break-in) |
| Footwear Construction | The way various sections of the footwear are |
| (FC) | combined (e.g., stitching, glued, layers of |
| | soles) |
| Foot Shape (FS) | Percentage overlap of 3D models of foot and |
| | footwear surfaces and point cloud; effect of |
| | footwear material and construction on the foot |
| Foot Pathology (FP) | Effect of FD, FM, and FC on an existing |
| | clinical foot condition (e.g., bunion) |
| Personal Gait and | Interaction between a person's walking |
| Biomechanics | pattern each of FD, FM, and FC |
| Parameters (PGP) | |

In one example, the fit score may be calculated using the factors in Table 2 as shown below:

Footwear Fit Score(FFC)=x*FS+y*FP+z*PGP

where:
x, y, z are weights determined by a classification machine learning algorithm (e.g., Principal Component Analysis (PCA));
FFC, FS, FP, PGP each range from 0-100;
FS, FP, FC are defined as:

FS=a1*FD+b1*FM+c1*FC

FP=a2*FD+b2*FM+c2*FC

PGP=a3*FD+b3*FM+c3*FC

where:
an, bn, cn are weights determined by a classification machine learning algorithm (e.g., Principal Component Analysis (PCA));
n={1, 2, 3} corresponds to FZ, FP, and PGP, respectively
an+bn+cn=1 for each of n=1, 2, or 3
FD, FM, FC each range from 0-100.

In one embodiment, a method of operating the personalized footwear production and recommendation engine 336 includes receiving at least one personal foot shape attribute associated with the user; receiving at least one personal pathology attribute associated with the user; receiving at least one personal gait and biomechanics attribute associated with the user; and/or receiving at least one contextual attribute associated with the user. It is contemplated that each of the foot shape, pathology, gait, biomechanics, and contextual attributes are not required so the engine 336 may receive only one of these attributes or any combination of one or more of these attributes. The method may also include receiving at least one footwear attribute with the user. In some approaches, the footwear attribute may have been determined based on one or more of at least one personal foot shape attribute, the at least one personal gait and biomechanics attribute, the at least one personal pathology, and the at least one personal contextual attribute. It is also contemplated that a footwear attribute may have been pre-determined based on other factors. Such attributes may be analyzed by engine 336 and used to generate one or more recommendations or to produce one or more personalized footwear products in accordance with one or more of the methods described herein.

In some aspects, the systems and methods described herein may be employed to provide updated recommendations, personalized footwear, and/or personalized shoe lasts or molds that can be employed for making personalized shoes. This may be particularly valuable, e.g., for individuals with certain foot pathologies, sizes, conditions and/or to capture the changes in one's foot, gait, biomechanics, and even footwear usage, over time. By one approach, the methods herein may be leveraged to produce made-to-fit footwear for a particular individual that is designed in light of the particular individual's foot pathologies, gait, biomechanics, and other usage-related aspects. Furthermore, the made-to-fit footwear is likely to evolve over an individual's lifetime and the analysis of footwear worn by the particular individual, along with potentially analyzing updated scans and other sensed information, may be leveraged to adjust the footwear recommendation or footwear manufactured, to account for changes. Further, receiving feedback on previously recommended or manufactured footwear creates an iterative process that results in a particular individual receiving updated recommendations or footwear over time. This method is in contrast to the standard mass manufacture of footwear that provides limited sizing options and that is built on a limited understanding of consumer needs, resulting in poor fit and thereby poor health (in light of the documented health consequences of the wearing of improperly sized footwear).

In one illustrative embodiment, discussed further below, the systems and methods employ one or more sensors in footwear to obtain data on, for example, temperature, humidity, acceleration, pressure, alignment, posture/tilt, and/or other footwear attributes during footwear usage to provide recommendations based on how a particular user wears the footwear. By one approach, the measured data may be compared to other measured attributes from a database for comparison purposes. Furthermore, in some embodiments, the previously worn footwear is analyzed to determine a degree of wear and wear patterns, among other aspects.

In use, the sensed data may be combined with other data provided and/or gathered from the user. For example, the methods herein may leverage both two-dimensional measurements, three-dimensional measurements, and dynamic measurements, such as, for example, foot measurements, foot scans, still image, and/or video data obtained by a camera or sensor external to the footwear, and/or shoe-mounted sensors configured to obtain data on the microclimate within the footwear as described below. By leveraging some or all of this data, the systems and methods herein assist with reducing the major shoe pain points of users including heel slippage, arch support, and toe box fitment. For example, while ball width or girth, heel diagonal, and arch height may be statically measured, dynamic analysis of the footwear in use permits measurement of the sole flexion point, the plantar or dorsiflexion point, and the level of arch flexibility or rigidity, and accommodating for these factors greatly improves wearer comfort levels.

As described below, the methods and systems are configured to measure humidity and temperature (to ascertain the microclimate within the footwear being worn) and acceleration and pressure (to ascertain a user's alignment and gait), which may then be accounted for in the personalized footwear recommendation and/or manufacture.

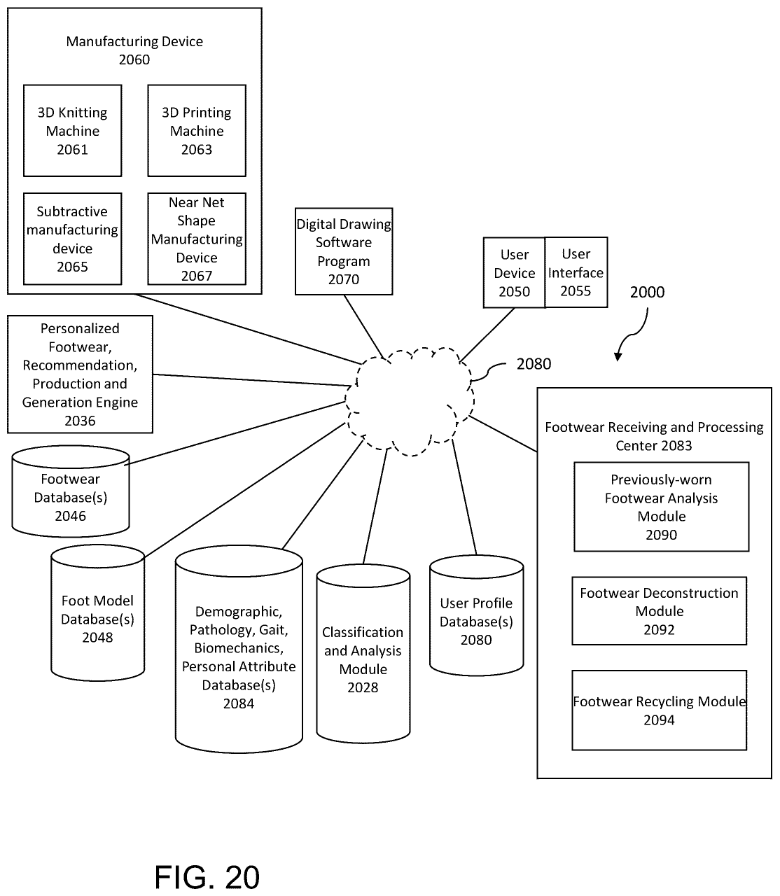

FIG. 14 illustrates an exemplary method 1400 of providing or updating a personalized footwear recommendation based at least in part on analyzing footwear condition data to determine a sensed personal attribute associated with a user. In some embodiments, one or more of the steps of method 1400 may be executed in conjunction with the personal attribute analysis module 328 described with reference to FIG. 3. In some approaches, both physical and/or contextual information, may be associated with the user in a database, such as the databases described in further detail below with reference to FIG. 20 or those described above with respect to FIG. 3.

The method 1400 includes identifying 1405 a user profile having previously worn or recommended footwear associated with the user. Receiving and analyzing 1410 footwear condition data associated with the user from one or more sensors. For example, the sensors may include a pressure sensor, accelerometer, a gyroscope, a humidity sensor, and/or a temperature sensor, among others.

The method 1400 also includes determining 1415 the sensed personal attribute to associate with the user profile based on the footwear condition data from one or more sensors. For example, the sensors may include a pressure sensor, accelerometer, a gyroscope, a humidity sensor, and/or a temperature sensor, among others.

In step 1420, the method 1400 includes receiving personal attribute data, which may include both physical and contextual data, to associate with the user profile. The method also includes providing or updating 1425 the personalized footwear recommendation, at least in part, based on the footwear condition data, the sensed personal attribute, and/or the physical or contextual personal attribute. The footwear recommendation may include at least one of recommendation regarding size, length, width, material type, brand, model, or combination thereof, of footwear. The physical or contextual attributes meaning, the contextual attributes described above with reference to FIG. 3. The physical attributes include, but not limited to the personal attributes described in FIG. 3 above, namely, the foot shape attributes, pathology attributes, or gait and biomechanics attributes.

The method 1400 may repeat after providing or updating 1425 the personalized footwear recommendation back to identifying 1405 a user profile having previously worn or recommended footwear associated therewith. In this manner, the method may be iterative and continuously useful to users.

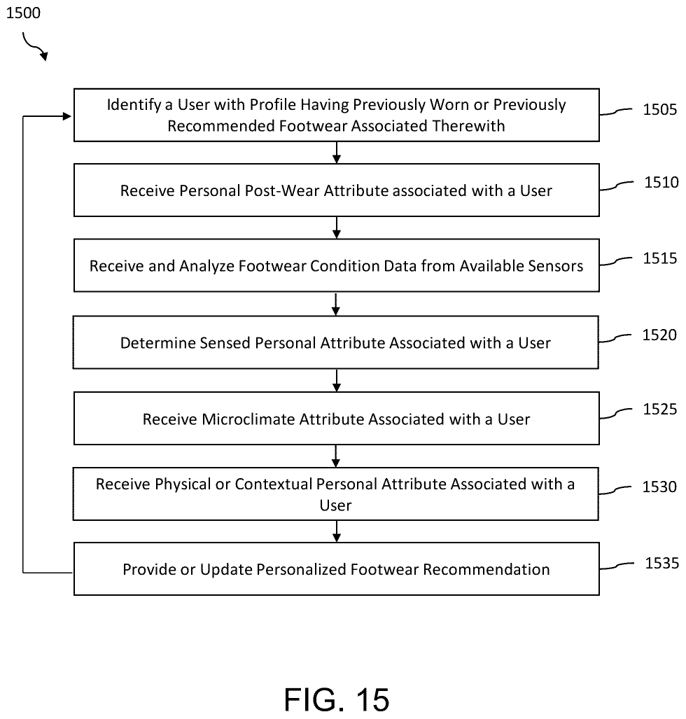

FIG. 15 illustrates an exemplary method 1500 of providing or updating a personalized footwear recommendation in accordance with some embodiments. In some embodiments, one or more of the steps of method 1500 may be executed in conjunction with the personal attribute analysis module 328 described with reference to FIG. 3. In some approaches, both physical and/or contextual information, may be associated with the user in a database, such as the databases described in further detail below with reference to FIG. 20.

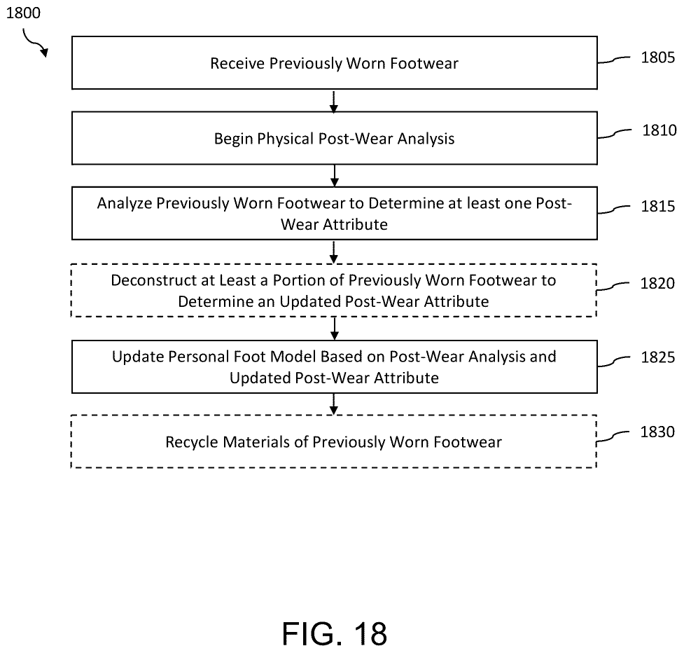

The method 1500 includes identifying 1505 a user profile having previously worn or recommended footwear associated with the user. In some embodiments, the method includes receiving 1510 a personal post-wear attribute associated with the user profile, where the personal post-wear analysis is used to determine the personal post-wear attribute, such as the analysis described in further detail below with reference to FIG. 18.

The method 1500 also typically includes receiving and analyzing 1515 footwear condition data associated with the user profile from one or more sensors. For example, the sensors may include a pressure sensor, accelerometer, a gyroscope, a humidity sensor, a temperature sensor, or any other available sensor. The method 1500 also includes determining 1520 the sensed personal attribute to associate with the user profile based on the footwear condition data.

The method 1500 also includes receiving 1525 a microclimate attribute associated with the user profile. The microclimate attribute determined by a microclimate analysis which analyzes data at least in part from at least one of a humidity sensor or a temperature sensor. The analysis determines aspects of temperature and/or humidity within the footwear with sensors placed in certain portions throughout the footwear to determine a localized microclimate in a certain portion of the footwear. The microclimate data may be used to update the footwear recommendation, or the user profile accordingly through the use of a processor or an electronic user device. In addition to the microclimate data sensed within the shoe, in some embodiments, the methods and systems described herein may solicit user preference or assessment data regarding how the user felt about or responded to the various sensed microclimate levels within the footwear. The microclimate, at least in part, may be determined from data from the humidity and/or temperature sensor and may be used to determine a user's preferred microclimate for comfort, but may also have a predefined database to determine a footwear recommendation based on other physical or contextual personal attributes discussed above, include but not limited to, geographic location such as altitude, ambient humidity of the surrounding area, or time of year.

In some configurations, the method 1500 also includes receiving 1530 personal attribute data, both physical and/or contextual, to associate with the user profile. The method also includes providing or updating 1535 the personalized footwear recommendation at least in part based on the footwear condition data, the sensed personal attribute, or the physical or contextual personal attribute. The footwear recommendation may include at least one recommendation regarding size, length, width, material type, brand, model, or combination thereof, of footwear. The physical or contextual attributes may include, the contextual attributes described above with reference to FIG. 3. The physical attributes including but not limited to the personal attributes described in FIG. 3 above, namely, the foot shape attributes, pathology attributes, or gait and biomechanics attributes.

The method 1500 may repeat after providing or updating 1535 the personalized footwear recommendation back to identifying 1505 a user profile having previously worn or recommended footwear associated therewith. Indeed, while the initial step 1535 may provide a personalized footwear recommendation, subsequent analysis may update the previous recommendation.

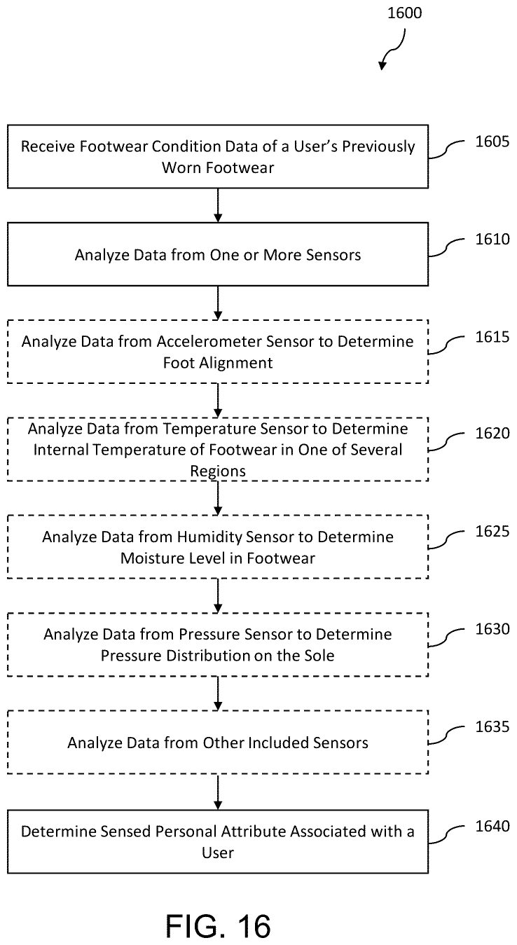

FIG. 16 illustrates an exemplary method 1600 of determining a sensed personal attribute in accordance with some embodiments. The method 1600 includes receiving 1605 footwear condition data of a user's previously worn footwear. The footwear having been worn for a duration of time. In some configurations, the duration of time is several months. In other configurations, the duration of time is about 6 months, but shorter and longer durations are contemplated herein. The method 1600 further includes analyzing 1610 data from one or more sensors.

Analyzing 1610 data from the one or more sensors optionally includes analyzing 1615 data from an accelerometer. By one approach, the accelerometer assists with determination of foot alignment in the footwear. Furthermore, the accelerometer may have other uses such as identifying and monitoring foot strike and foot alignment patterns throughout an individual's gait cycle when walking, running, and performing other athletic and physical activities and monitoring mobility of patients managing medical conditions such as those recovering from a stroke. The present disclosure contemplates both a single accelerometer and several accelerometers strategically placed within the footwear to determine the acceleration or orientation in several regions of the footwear.

Analyzing 1610 data from one or more sensors optionally includes analyzing 1620 data from a temperature sensor. The temperature sensor may determine internal temperature inside the footwear or around the foot, but the temperature sensor may have other uses such as measuring localized temperature variations throughout different regions of the foot which may be indications of tissue injury. The present disclosure contemplates both a single temperature sensor and several temperature sensors strategically placed within the footwear to determine the temperature in several regions of the footwear, and to aid in determining the microclimate attribute described above in FIG. 15.

Analyzing 1610 data from one or more sensors optionally includes analyzing 1625 data from a humidity sensor, but the humidity sensor may have other uses such as providing humidity values which may indicate environments of microbial growth that influence spread of potential bacterial or fungal infections. The humidity sensor may determine moisture level of the interior of the footwear. The present disclosure contemplates both a single humidity sensor and several humidity sensors strategically placed within the footwear to determine the humidity in several regions of the footwear, and to aid in determining the microclimate attribute described above in FIG. 15. It is further contemplated that the humidity sensor may track the humidity of the outside surroundings in conjunction with and/or separate from the interior of the footwear.

Analyzing 1610 data from one or more sensors optionally includes analyzing 1630 data from a pressure sensor. The pressure sensor may determine regions of high pressure on the sole (and/or other areas) of the footwear, but the pressure sensor may have other uses such as identification of foot strike patterns and foot alignment during an individual's gait cycle. The present disclosure contemplates both a single pressure sensor and several pressure sensors strategically placed within the footwear. The present disclosure also contemplates one pressure sensor covering substantially all of the sole of the footwear.

The present disclosure further contemplates other sensors to track other footwear aspects, such as a gyroscope. The gyroscope may, by one approach, assist with determination of foot alignment in the footwear. Furthermore, the gyroscope may have other uses such as identifying and monitoring foot strike and foot alignment patterns throughout an individual's gait cycle when walking, running, and performing other athletic and physical activities and monitoring mobility of patients managing medical conditions such as those recovering from a stroke. The present disclosure contemplates both a single gyroscope and several gyroscopes strategically placed within the footwear to determine the acceleration or orientation in several regions of the footwear.

The method 1600 further includes determining 1640 a sensed personal attributed associate with the user and may update the user profile through the use of a processor and/or an electronic user device. This method 1600 may be associated with method 1400, specifically determining 1415 a sensed personal attribute. This method 1600 may be associated with method 1500, specifically determining 1520 a sensed personal attribute.

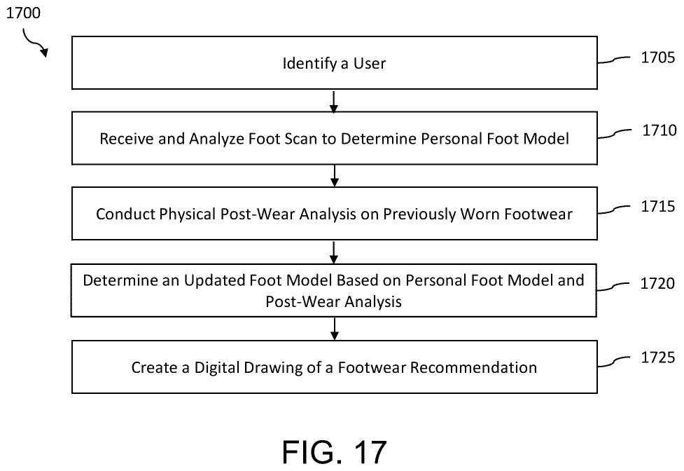

FIG. 17 illustrated an exemplary method 1700 of creating a digital drawing, such as, e.g., a computer-aided design (CAD) drawing, of a footwear recommendation in accordance with some embodiments. The method 1700 typically includes identifying 1705 a user. This user may be a user with previously recommended footwear, a new user, a user with a user profile, or any other user. In one illustrative approach, the method 1700 includes receiving and analyzing 1710 a foot scan to determine a personal foot model. The foot scan may come from an electronic device, such as a phone, a computer, a scanning module, or any other imaging device that contains an image sensor (e.g., a camera). Foot scans may also come from a commercially available foot scanner and may use other imaging technologies, such as laser, non-ionizing radiation, and/or low ionizing radiation

The method 1700 also includes conducting 1715 a physical post-wear analysis on previously worn footwear. The previously worn footwear may be previously recommended footwear, or any other footwear worn for a duration of time. The physical post-wear analysis described in further detail below with reference to FIG. 18.

The method 1700 also includes determining 1720 an updated foot model based on the personal foot model from the foot scan of 1710 and the physical post-wear analysis of step 1715, which may update the user profile accordingly through the use of a processor or an electronic user device.

The method 1700 also includes creating 1725 a digital drawing of a footwear recommendation. The digital drawing of a footwear recommendation may be done by creating a computer aided design (CAD) drawing, however other known forms of digital drawings are contemplated herein. The footwear recommendation may be of the footwear, a portion of the footwear, or a footwear last conforming to the user's foot based on the updated foot model of step 1720, or may update the user profile accordingly through the use of the processor or the electronic user device.

FIG. 18 illustrates an exemplary method 1800 of conducting a physical post-wear analysis. The method includes receiving 1805 previously worn footwear. The previously worn footwear contemplated is not limited to previously recommended footwear, but it may be previously recommended footwear or previously recommended footwear with any of the sensors as described with reference to FIG. 16. By some approaches, the previously worn footwear has been worn for over about 6 months however, shorter and longer durations are contemplated herein. The method 1800 also includes beginning 1810 the physical post-wear analysis which includes analyzing 1815 the previously worn footwear to determine at least one post-wear attribute. The method 1800 also optionally includes deconstructing 1820 at least a portion of the previously worn footwear to determine an updated post-wear attribute and may update the user profile accordingly through the use of an electronic user device.

The method 1800 also includes updating 1825 a personal foot model based on at least one of the post-wear attributes and/or the updated post-wear attribute, which may update the user profile accordingly. The method 1800 optionally includes recycling 1830 the materials of the previously worn footwear, either in whole, or in portions if deconstructed. For example, the shoe may be partially (or wholly) deconstructed to conduct a portion of the data analysis, which thereby breaks down the shoes into constituent pieces that render themselves better suited for being recycled. The ability to recycle their footwear and improve their next pair of shoes is attractive to many consumers.

In some configurations, the physical post-wear analysis of previously worn footwear helps determine certain aspects of the fit and/or usage of the previously worn footwear. The post-wear analysis looks, for example, at the wear, or wear pattern, of the sole of the previously worn footwear, for example, the wear on the heel region of the previously worn footwear, material degradation, and other indications on the sole, insole, midsole, or other portions of the footwear to determine pressure points where high pressure and wear has been put on the previously worn footwear. The physical post-wear analysis may include deconstructing at least a portion of the previously worn footwear. In addition, the methods described herein may further include recycling all or portions of the previously worn footwear.

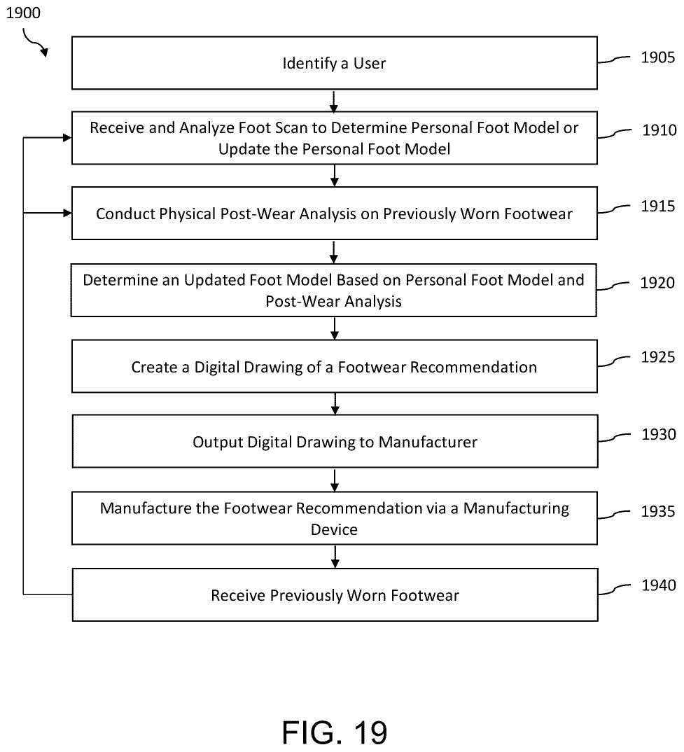

FIG. 19 illustrates an exemplary method 1900 of manufacturing, repeating, and updating a footwear recommendation. The method 1900 includes identifying 1905 a user. The method 1900 also includes receiving and analyzing 1910 a foot scan of the user's foot to determine a personal foot model. The foot scan, as described above, may be provided, in part, from a smartphone, computer, tablet, scanning module, or any other scanning or imaging device. The method 1900 also typically includes conducting a physical post-wear analysis on the previously worn footwear as described above with reference to FIG. 18. In some configurations, the method 1900 includes determining 1920 an updated foot model based on the post-wear analysis described above with reference to FIG. 18, and the personal foot model of step 1910.

The method 1900 also includes creating 1925 a digital drawing, such as a CAD drawing, of a footwear recommendation, based at least in part the personal foot model and/or the updated foot model. The method 1900 also includes outputting 1930 the digital drawing to a manufacturer or a manufacturing device. The method 1900 also includes manufacturing 1935 the footwear recommendation. Manufacturing the footwear recommendation may be done 2600 through the use of additive, subtractive, and near net shape manufacturing 2067 and may include 3D printers 2061, laser cutters 2065, 3D knitting devices 2063, a third-party manufacturer, or any other manufacturing means.

Once the manufactured footwear or recommended footwear has been worn for a duration of time, the user may return the footwear for analysis. Accordingly, in step 1940, the method includes receiving 1940 previously worn footwear. The duration of time may include, for example, about 6 months, however shorter and longer durations of time are contemplated herein. In practice, once the user has worn the shoes for a duration of time, the user may return the worn footwear such that the method includes receiving 1940 previously worn footwear. Further, the method 1900 may continue after receiving 1940 the footwear to (a) step 1910 described above regarding receiving and/or analyzing a foot scan and/or (b) step 1915 such that the method conducts additional post-wear analysis of the previously worn footwear recommendation. In such a configuration, the user profile may be updated accordingly through the use of a processor or an electronic user device.

The method 1900 contemplates the use of footwear lasts and updating footwear lasts, in physical and/or digital form. In some configurations, the method 1900 includes identifying a user 1905 and receiving and analyzing 1910 a foot scan to determine a personal foot model. The foot scan, via a processor, may update a base footwear template based on the personal foot model. The method 1900 also includes conducting 1915 a physical post-wear analysis on the previously worn footwear, similar to that described above. The method 1900 also includes determining 1920 an updated foot model based on the personal foot model and post-wear analysis.

It is further contemplated that the processor may digitize the updated foot model, creating a personalized footwear last. The digital personalized footwear last may be further updated to create a customized user footwear last by, for example, changing or manipulating particular vertices on the digital user personalized footwear last. This may be done to increase comfort or other attributes associated with the user contemplated herein.

It is further contemplated that an automated user footwear last may be created from the updated personalized footwear last or customized user footwear last. The updated personalized footwear last or customized user footwear last may be further updated through the use of an algorithm which may be a machine learning algorithm to create the automated user footwear last.

In some embodiments, one of the above footwear lasts may be considered a digital drawing as method 1900 also includes creating 1925 the digital drawing. The digital drawing, or one of the above footwear lasts, may be output 1930 to a manufacturer, where the digital drawing or footwear last is manufactured 1935.

Footwear lasts may be fabricated using additive 2061, 2063, subtractive 2065, and/or near net shape 2067 manufacturing throughout the method or process and may provide a benefit of enabling custom-fitted or well-lasted shoes, which enable close and secure fit of the shoe on the foot based on an individual's foot contours, which enhances footwear support and comfort.

FIG. 20 illustrates an exemplary system 2000 for providing personalized footwear in accordance with some embodiments. An exemplary data structure is illustrated in FIG. 20; however, it should be understood that other suitable data structures may be used by the system 2000.

The components of system 2000 may communicate directly or indirectly, such as over one or more distributed communication networks, such as network 2080. For example, network 2080 may include LAN, WAN, Internet, cellular, Wi-Fi, bluetooth, and other such communication networks or combinations of two or more such networks. Various components of system 2000 may also be hardwired.

It is contemplated that one of more processors may be associated with any of the components described in system 2000. The term processor refers broadly to any microcontroller, microprocessor, computer, control-circuit, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The processor may be configured (for example, by using corresponding programming stored in a memory as will be well understood by those skilled in the art) to carry out one or more of the methods, steps, actions, and/or functions described herein.

The system 2000 may include one or more electronic user devices 2050. The user devices may be configured to receive recommendations, prompts, queries, surveys, notifications, alerts, instructions, user input, or other information. The electronic user device may include, for example, a smart phone, a tablet, a laptop, a personal computer, a smart watch, etc. Further, the electronic device may also be equipped with an image sensor (e.g., a camera). The user devices 2050 may be used to capture a foot scan as described above with reference to FIGS. 17 and 19.

One or more user interfaces 2055 may be associated with the electronic user devices 2050. The user interfaces may be used for user input and/or for output display. For example, the user interface may include any known input devices, such one or more buttons, knobs, selectors, switches, keys, touch input surfaces, audio input, and/or displays, etc. The user interfaces 2055 may further include lights, visual indicators, display screens, etc. to convey information to a user, such as but not limited to the communication of: footwear recommendations; instructions regarding capturing the foot scan. In this manner, the system may receive data or information regarding the foot scan or physical or contextual personal attributes associated with a user via a user interface.

In one embodiment, the user may use one or more electronic user devices to complete a virtual footwear assessment by submitting at least one of the following: answers to a series of questions or one or more captured pictures or videos of the user's feet. In an exemplary embodiment, one or more sensors and/or one or more cameras from the electronic user device may be utilized to acquire any necessary data (e.g., pictures, videos, etc.) from the user to make a personalized footwear recommendation or otherwise assess the footwear needs of a user.

The system 2000 may also include various modules to provide personalized footwear or generate personalized footwear recommendations for a user. In some embodiments, the system 2000 may include one or more of a classification and analysis module 2028, similar to that described above as the personal attribute analysis module 328 with reference to FIG. 3.

The system 2000 may also include various databases to provide personalized footwear or generate personalized footwear recommendations for a user. In some embodiments, the system 2000 may include one or more of a user profile database(s) 2080, a demographics, pathology, gait, biomechanics, personal attribute database(s) 2084, a foot model database(s) 2048, or a footwear database(s) 2046.

The user profile database may include a profile that is updated with the data gathered in any of the above-described steps and may be communicable with the one of more processors or the one or more electronic user devices. The demographics, pathology, gait, biomechanics, and personal attribute database 2084 may be communicable with the classification and analysis module 2028. The demographics, pathology, gait, biomechanics, and personal attribute database 2084 is similar to the output of the foot shape module 302, the foot pathology module 304, the gait and biomechanics module 306, and the context module 308 as described in detail above with reference to FIG. 3.

The food model database 2084 may be used to store or communicate with the one or more processors or the one or more electronic user devices. The foot model database may store one or more of the foot scans, the personal foot model, the updated foot model, or any other foot model or scan described herein. The footwear database 2046 may be used to store or communicate with the one or more processors or the one or more electronic user devices. The footwear database may store one or more of the attributes described herein, or other data relating to already made footwear to compare to the data received from one or more of the foot scan, personal foot model, or updated foot model.

The system may further include a footwear receiving and processing center 2083. The footwear receiving and processing center 2083 includes a previously worn-footwear analysis module 2090, a footwear deconstruction module 2092, and a footwear recycling module 2094. The footwear receiving and processing center 2083 uses methods similar to those described above with reference to FIG. 18. The footwear receiving and processing center 2083 may be conducted physically by means of a human operator, or automatically through the use of a scanning device.

The system may further include a personalized footwear production and recommendation engine 2036 similar to the personalized footwear production and recommendation engine 336 described above in detail with reference to FIG. 3. The personalized footwear production and recommendation engine 2036 may employ methods, such as those described with reference to FIG. 14, 15, 17, or 19, to utilize footwear condition data, sensed personal attributes, post-wear attributes, microclimate attributes, physical or contextual personal attributes, personal foot models, updated foot models, or digital drawings acquired and generated by the system 2000. The personalized footwear production and recommendation engine 2036 may merge any of the above listed attributes, models, data, or drawings to generate personalized footwear and personalized footwear recommendations.

The personalized footwear production and recommendation engine 2036 may generate specifications, size, style, materials, material properties (e.g., breathability, viscoelasticity, stretchability, tear strength, flexibility, water resistance, abrasion resistance, etc.), weight, tongue feature(s), lining feature(s), insole feature(s), toe box feature(s), outsole feature(s), upper feature(s), sole feature(s), heel height, degrees of foot support, construction (i.e., stitching, mesh), and/or product recommendations for a user. In some approaches, these recommendations may be sent to a user via the one or more processors or the one or more electronic user device.

The personalized footwear production and recommendation engine 2036 may rely on predefined footwear attributes such as specifications, size, style, materials, material properties (e.g., breathability, viscoelasticity, stretchability, tear strength, flexibility, water resistance, abrasion resistance, etc.), weight, tongue feature(s), lining feature(s), insole feature(s), toe box feature(s), outsole feature(s), upper feature(s), sole feature(s), heel height, degrees of foot support, construction (i.e., stitching, mesh), and/or product recommendations for a user.

It is also contemplated that the personalized footwear production and recommendation engine 2036 may generate personalized footwear. For example, the personalized footwear production and recommendation engine 2036 may send a signal to one or more manufacturing devices to control device operation. Manufacturing devices 2060 may include additive, subtractive 2065, and/or near net shape 2067 manufacturing devices such as 3D printing machines 2061 and/or 3D knitting machines 2063, laser cutters, etc. In some embodiments, the personalized footwear production and recommendation engine 2036 may also be communicable with a manufacturing execution system to control one or more operational parameters for a footwear manufacturing process. It is contemplated that the footwear production engine 2036 may control one or more manufacturing devices to manufacture a custom footwear product for a particular individual or user and/or to mass manufacture footwear products.

The personalized footwear production and recommendation engine 2036 may also provide one or more specifications to a digital drawing software program 2070. In some approaches, the personalized footwear production engine 2036 may, for example, instruct a 3D printing machine to produce a portion of a shoe, such as, e.g., the sole, insole, and/or footbed and may instruct a 3D knitting machine to complete other portions of the shoe, such as, e.g., the upper and tongue. Furthermore, the personalized footwear production engine 2036 also may subsequently instruct the 3D printing machine to produce additional portions of the shoe, such as, e.g., a toe cap and may instruct a laser cutter to cut section(s) of material to achieve accurate shape and size of shoe or shoe components.

In another embodiment, the personalized footwear and recommendation engine 2036 may also be communicable with a shipping system. In one embodiment, the engine 2036 may send a signal to the shipping system to automatically place an order for and/or ship one or more footwear products to a particular user and/or individual. In one example, the footwear product(s) could be shipped directly to the user. In another example, the footwear products could be shipped to a store or nearby location for pick-up. In another approach, the engine 2036 may first identify one or more footwear products for a particular user and/or individual. In one approach, the user may select one or more of the identified footwear products to place an order and have the products shipped. In some embodiments, the engine 2036 may both control the manufacturing of a footwear product for a particular user and automatically ship the product to the user. In this manner, the engine 2036 may customize orders for a particular user. It is also contemplated that, after shipping or otherwise providing one or more custom footwear products to a user, the system 2000 may also receive feedback on the footwear product(s). For example, the system 2000 may transmit a questionnaire or survey to the user to receive information, for example, on the comfort, fit, aesthetics, or other experiences with the footwear product and for example, whether the user plans to keep the footwear product or would like certain adjustments to the product.

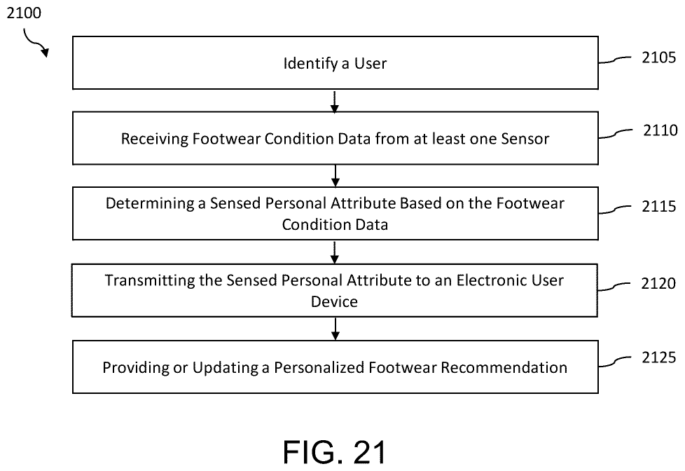

FIG. 21 illustrates an exemplary method 2100 of updating a footwear recommendation in accordance with some embodiments. The method 2100 includes identify 2105 a user. The method 2100 also includes a processor receiving 2110 footwear condition data from at least one sensor. The method 2100 also includes the processor determining 2115 a sensed personal attribute based on the footwear condition data. The method 2100 also includes the processor transmitting 2120 the sensed personal attribute to an electronic user device. The method 2100 also includes updating 2125 a personalized footwear recommendation. The processor of method 2100 may be one or more processors, such as one in the footwear, a second processor in the electronic user device, as described above with reference to FIG. 20. The one or more processors or electronic user devices may communicate and transmit data directly or indirectly throughout the method or process.

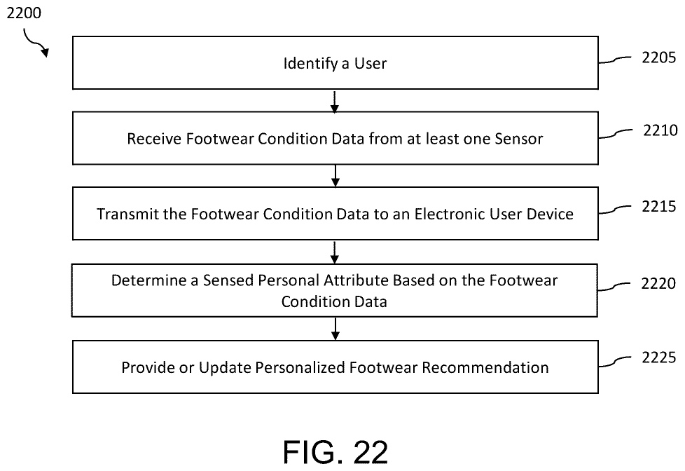

FIG. 22 illustrates an exemplary method 2200 of providing and updating a footwear recommendation in accordance with some embodiments. The method 2200 includes identifying 2205 a user. The method 2200 also includes a processor receiving 2210 footwear condition data from at least one sensor. The method 2200 also includes the processor transmitting 2215 the footwear condition data to an electronic user device. The method 2200 also includes the electronic user device determining 2220 a sensed personal attribute based on the footwear condition data which also updates 2225 a personalized footwear recommendation. The processor of method 2200 may be one or more processors, such as one in the footwear, a second processor in the electronic user device, as described above with reference to FIG. 20. The one or more processors or electronic user devices may communicate and transmit data directly or indirectly throughout the method or process.

In one illustrative embodiment of providing a personalized footwear recommendation, at least one electronic device, including an image sensor (e.g., a camera), at least one sensor, and at least one processor communicable with one another may be used to provide a personalized footwear recommendation. The at least one processor may receive image data from the electronic user device and/or the at least one sensor. The image data may include at least a portion of at least one foot of a user.

The at least one processor determines at least one foot shape attribute to associate with the user based, at least in part, on the image data. A user profile may be created and updated accordingly by at least one of the at least one processor or the at least one electronic user device. Determining the at least one foot shape attribute is similar to the analysis described in detail above with reference to FIG. 5.

The at least one processor also may determine at least one pathology attribute to associate with the user based, at least in part, on the image data. The user profile may be further updated accordingly by at least one of the at least one processor or the at least one electronic user device. Determining the at least pathology attribute is similar to the analysis described in detail above with reference to FIG. 7.

The at least one processor may also receive video data captured by the image sensor. The video data may include a video of the user's gait, such as the user walking. The at least one process may also determine at least one gait attribute associated with the user based, at least in part, on the video data. The user profile may be further updated accordingly by at least one of the at least one processor or the at least one electronic user device. Determining the at least gait attribute is similar to the analysis described in detail above with reference to FIG. 9.

The at least one processor may also receive information regarding a physical or contextual personal attribute. The at least one processor may receive this information via the user interface associated with the electronic user device. The physical or contextual personal attributes being those described in detail above, with reference to FIG. 3. The user profile may be further updated accordingly by at least one of the at least one processor or the at least one electronic user device. Determining the at least physical or contextual personal attribute is similar to the analysis described in detail above with reference to FIG. 11.

The at least one processor may also receive information regarding a post-wear analysis. The at least one processor may receive this information via the user interface associated with the electronic user device. The at least one processor may also determine a post-wear attribute to associate with the user. The user profile may be further updated accordingly by at least one of the at least one processor or the at least one electronic user device. Determining the post-wear attribute is similar to the analysis described in detail above with reference to FIG. 18.

The at least one processor may also receive information regarding footwear condition data. The at least one processor may receive this information via the at least one sensor. The at least one processor may also determine a sensed personal attribute to associate with the user. The user profile may be further updated accordingly by at least one of the at least one processor or the at least one electronic user device. Determining the sensed personal attribute is similar to the analysis described in detail above with reference to FIG. 16.

The at least one processor may also receive information regarding a microclimate analysis. The at least one processor may receive this information via the user interface associated with the electronic user device. The at least one processor may also determine a personal microclimate attribute to associate with the user. The user profile may be further updated accordingly by at least one of the at least one processor or the at least one electronic user device. Determining the personal microclimate attribute is similar to the analysis described in detail above with reference to FIG. 15.

The at least one processor may determine at least one footwear recommendation based on the above attributes to provide to the user via the user interface associated with the at least one electronic user device.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

1-56. (canceled)

57. A method for providing personalized footwear, the method comprising:
receiving a foot scan of a user;
determining a personalized foot model based, at least in part, on the foot scan;
receiving information regarding a post-wear analysis based on previously worn footwear;
determining at least one post-wear attribute associated with the user, based, at least in part, on the post-wear analysis; and
determining at least one personal footwear recommendation to associate with the user based, at least in part, on the personalized foot model.

58-65. (canceled)

66. The method of claim 57, wherein the post-wear analysis includes receiving a previously worn footwear and determining the post-wear attribute based, at least in part, on analysis of the previously worn footwear.

67-71. (canceled)

72. The method of claim 57, further comprising determining an updated personalized foot model to associate with the user based, at least in part, on the personalized foot model and the post-wear attribute.

73. The method of claim 72, further comprising updating a base footwear last template to create the updated personalized foot model based on the foot scan.

74. The method of claim 73, further comprising updating the base footwear last template to create a digital user personalized footwear last based on the updated personalized foot model further.

75. The method of claim 74, further comprising updating the digital user personalized foot last by changing particular vertices and faces on a surface of the digital user personalized footwear last based, at least in part, on the personalized foot model and the updated personalized foot model to create a customized user footwear last.

76. The method of claim 75, further comprising updating the customized user footwear last automatically through use of a machine learning algorithm to create an automated user footwear last.

77. (canceled)

78. A method for determining personalized footwear, the method comprising:
receiving footwear condition data measured by at least one sensor for a user utilizing a particular piece of footwear;
determining at least one personal attribute based, at least in part, on the footwear condition data, via at least one processor;
receiving information regarding at least one physical or contextual personal attribute associated with the user; and
determining at least one footwear attribute to associate with the user based, at least in part, on the at least one personal attribute obtained via the at least one sensor and the at least one physical or contextual personal attribute.

79-80. (canceled)

81. The method of claim 78, wherein determining a footwear recommendation is based, at least in part, on the at least one footwear attribute.

82. The method of claim 81, wherein recommending the footwear recommendation includes at least one of a recommendation regarding size, length, width, girth, material type, brand, model, or combination of thereof, of footwear.

83-84. (canceled)

85. The method of claim 78, further comprising identifying at least one predefined footwear attribute to associate with the user based, at least in part, on the at least one personal attribute and the at least one physical or contextual personal attribute from at least one database comprising a plurality of predefined footwear attributes via the at least one processor.

86. The method of claim 85, wherein the plurality of predefined footwear attributes includes a footwear material type, a footwear material property, a footwear material composition, and a footwear construction involving one or more materials.

87. The method of claim 78, further comprising updating a user profile based, at least in part, on the at least one personal attribute and the at least one physical or contextual personal attribute, via the at least one processor.

88. The method of claim 78, further comprising receiving information regarding a personal post-wear attribute associated with the user, and
determining at least one updated footwear attribute to associate with the user based, at least in part, on the personal post-wear attribute via at least one electronic user device and/or the at least one processor.

89. The method of claim 88, wherein the personal post-wear attribute includes heel erosion, heel wear, sole wear, insole wear, midsole wear, wear on other portions of the footwear, or material degradation.

90. The method of claim 88, further comprising identifying at least one predefined footwear attribute to associate with the user based, at least in part, on the post-wear attribute from at least one database comprising a plurality of predefined footwear attributes, via the at least one electronic user device and/or the at least one processor.

91-95. (canceled)

96. A method for providing personalized footwear, the method comprising:
receiving a foot scan of a user;
determining a personalized foot model based, at least in part, on the foot scan, via at least one processor,
receiving information regarding a post-wear analysis based on previously worn footwear;
determining at least one post-wear attribute associated with the user based, at least in part, on the post-wear analysis, via the at least one processor, and
determining at least one personal footwear recommendation to associate with the user based, at least in part, on the personalized foot model.

97-101. (canceled)

102. The method of claim 96, creating a computer aided design (CAD) drawing for the personalized foot model to facilitate design and manufacture of a personalized shoe last via the at least one processor.

103. The method of claim 102, wherein constructing at least a portion of the personalized footwear last by sending the CAD drawing to a manufacturing device.

104. The method of claim 96, wherein the post-wear analysis includes receiving a previously worn footwear and determining the post-wear attribute based, at least in part, on analysis of the previously worn footwear.

105-115. (canceled)
